SEQUENCE LISTING (4 sequences)

SEQ ID NO: 1 - protein, 38 aa, Aquifex Aeolicus
  ref <301>: AUTHORS: Decker et al
  ref <302>: TITLE: The Complete Genome of the Hyperthermophilic bacterium Aquifex Aeolicus
  ref <303>: JOURNAL: Nature
  ref <304>: VOLUME: 392
  ref <305>: ISSUE: 6674
  ref <306>: PAGES: 353358
  ref <307>: DATE: 1988-01-01
  ref <308>: DATABASE ACCESSION NUMBER: NC_00918
  ref <309>: DATABASE ENTRY DATE: 2005-12-02
  ref <313>: RELEVANT RESIDUES IN SEQ ID NO: (01)..(38)
MEKLDKILEELKLLLSSVSSLKELQEVRSKFLGSKGVI

SEQ ID NO: 2 - DNA, 72 bp, HOMO SAPIENS
  ref <308>: DATABASE ACCESSION NUMBER: UCSC Genomic tRNA Database
  ref <309>: DATABASE ENTRY DATE: 2009-02-01
  ref <313>: RELEVANT RESIDUES IN SEQ ID NO: (01)..(72)
gggaattagctcaagcggtagagcgctcccttagcatgcgagaggtagcgggatcgacgcccccattctcta

SEQ ID NO: 3 - DNA, 38 bp, HOMO SAPIENS
  ref <308>: DATABASE ACCESSION NUMBER: UCSC Genomic tRNA Database
  ref <309>: DATABASE ENTRY DATE: 2009-02-01
  ref <313>: RELEVANT RESIDUES IN SEQ ID NO: (01)..(38)
gggaattagctcaagcggtagagcgctcccttagcatg

SEQ ID NO: 4 - DNA, 38 bp, HOMO SAPIENS
  ref <308>: DATABASE ACCESSION NUMBER: UCSC Genomic tRNA Database
  ref <309>: DATABASE ENTRY DATE: 2009-02-01
  ref <313>: RELEVANT RESIDUES IN SEQ ID NO: (01)..(38)
ggccagtggcgcaatggataacgcgtctgactacggat

(19) United States
(12) Patent Application Publication
(10) Pub. No.: US 2016/0239603 A1
(43) Pub. Date: Aug. 18, 2016

(54) Computer-implemented associations of nucleic and amino acid sequence polymorphisms with phenotypes.

(71) Applicant: Michael James Brown, Rockville, MD (US)

(72) Inventor: Michael James Brown, Rockville, MD (US)

(21) Appl. No.: 14/624,694

(22) Filed: Feb. 18, 2015

(51) Int. Cl. G06F 19/18

(52) U.S. Cl. CPC G06F 19/18

(57) ABSTRACT

Computer-implemented methods that associate one-hundred percent of the nucleic or amino acid sequence polymorphisms of a particular length with an examined phenotype. Each association is documented by the number of case and control group individuals on whose sequences the polymorphism occurs, as well as relative risk, chi square, and correlation statistics. Association statistics are reported in various formats, such as alphabetically by polymorphism with associated statistic, by statistical value with associated polymorphism, or by polymorphism with associated statistic continuously from the beginning to the end of the chromosome, gene, or polypeptide of examined individuals. The computer user designates the range of results reported to the computer monitor and to a text report and, thus, can chose to report only needle-in-the-haystack results within a range of desired frequencies of occurrence, relative risks, chi squares, or correlations.

### CROSS-REFERENCE TO RELATED APPLICATIONS

Not Applicable

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable

### REFERENCE TO A SEQUENCE LISTING, A TABLE, OR A COMPUTER PROGRAM LISTING COMPACT DISC APPENDIX

Sequence data and computer programs for the working examples are appended to the present application and separately filed on CD-ROMs. These are incorporated by reference into the present specification. The total number of compact discs submitted is two, with one of these being a duplicate.

The discs each contain ten files. The files consist of one sequence file namely, AQ1.prj which was prepared with the USPTO's “Patent-IN 3.5” software, and three NCBI source files for this sequence namely, fasta.fcgi_files\fasta.fcgi.htm, fasta_files\fasta.htm, and viewer.fcgi_files\viewer.fci.htm. The Perl computer files, AQnt.pl, AQnt.pl, HSaa.pl and HSnt.pl were prepared with Perl computer software namely ActivePerl-5.8.7.815-MSWin32-x86-211909.msi and PESetup25-1.exe. All files were prepared on an IBM-PC using the MS Windows operating system. More particularly, the filenames, byte sizes, and creation dates for these files are as follow: (1) AQ1prj, 1.90 Mb, Feb. 7, 2015; (2) fasta.fcgi_files\fasta.fcgi.htm, 1.53 Mb, Jun. 21, 2006; (3) fasta_files\fasta.htm, 1.53 Mb, Dec. 26, 2011; (4) viewer.fcgi_files\viewer.fci.htm, 4.54 Mb, Jun. 21, 2006, (5) AQnt.pl, 2.05 Mb, Feb. 6, 2015; (6) HSaa.pl, 1.16 Mb, Feb. 6, 2015; (7) AQaa.pl, 1.49 Mb, Feb. 6, 2915; (8) HSnt.pl, 2.29 Mb, Feb. 5, 2015; (9) ActivePerl-5.8.7.815-MSWin32-x86-211909.msi, 12.7 Mb, Apr. 7, 2006; (10) PESetup25-1.exe, 3.28 Mb, Jun. 10, 2007.

A computer program is appended and included on the CD for each of the four working examples of the methodology of the present application. The versions of the working examples distinguish between between whole-genome and gene-specific sequence inputs and between nucleic and amino acid analyses, as follows: (1) Homo sapiens (i.e. humans), gene-specific sequence data input, nucleic acid analysis, program filename HSnt.pl; (2) Homo sapiens, gene-specific sequence data input, amino acid analysis, program filename HSaa.pl; (3) Aquifex aeolicus, whole-genome sequence data input, nucleic acid analysis, program filename AQnt.pl; and (4) Aquifex aeolicus, whole-genome sequence data input, amino acid analysis, program filename AQaa.pl.

The sequence data for the working examples was acquired from public sources and no proprietary interest in the sequence data itself is claimed. The sequence data is appended on CD because it was used to prepare the aquifex aeolicus working examples that demonstrate the methods of the present application.

For the aquifex aeolicus working examples the sequence data consists of the full nucleic acid sequence of the organism's single chromosome, which was input into the working example programs AQnt.pl and AQaa.pl by reference in the programming instructions to an external file containing the sequence data. The sequence listing for the aquifex aeolicus sequence data which was appended and included on the CD-ROM was prepared with the USPTO's “Patent-In 3.5” software. The filename for the sequence listing is: AQ1.prj. For the homo sapiens working examples HSnt.pl and HSaa.pl, sequence data consisting of homo sapiens tRNA gene and aaRS enzyme gene sequence data was copied from source files and directly input into the programming instructions. This sequence data, which consists of nucleic acid sequence data for tRNA genes of homo sapiens with each of the 46 different homo sapiens anticodons and for amino acid sequence data for 18 different aaRS enzyme genes, was not submitted on CD because the source files do not conform to the format for submission. However, this relatively short homo sapiens gene-specific sequence data is cited later in the application for including with the informational disclosure statement of reference materials.

### STATEMENT REGARDING PRIOR DISCLOSURES BY AN INVENTOR OR JOINT INVENTOR

There has not been any prior disclosures by an inventor or joint inventor.

### BACKGROUND OF THE INVENTION

(1) Field of the Invention

The fields related to the present invention include bioinformatics, computer processing, genetics, and medicine among others. The expected users of the methods described by the present application are persons interested in identifying the extent of differences between different sequences of nucleic or amino acids of individuals or groups of individuals. The most obvious uses of the methods relate to the identification of the nucleic or amino acid sequences implicated in the expression of diseases or traits, and this is the context in which this application is addressed. However, the methods may also be used in fields such as phylogenetics, forensics, agriculture, animal husbandry, and ancestry among others since in all of these fields people are interested in differences between the nucleic or amino acid sequences of individuals or groups.

(2) Description of Related Art

The computer-implemented methods described by the present application identify, detect, count, associate with an examined phenotype, and report various measures of association in various ways for each contiguous nucleic acid or amino acid sequence polymorphism of a particular sequence length from two (2) through and including ninety-nine (99) from the sequence data of examined individuals.

For this application digital data representing sequences of nucleotides (nts) of a particular length (called “CNSPs” referring to “contiguous nucleotide sequence polymorphisms”) from nucleic acid sequence data, such as from chromosomes or genes of an aggregate of all examined case and control group individuals are separately matched with the DNA sequence data, such as from chromosomes or genes, of each case or control group individual; or similarly, digital data representing sequences of amino acids of a particular length (called “CAASPs” referring to “contiguous amino acid sequence polymorphisms”) from amino acid sequence data, such as from polypeptides or proteins, of an aggregate of all examined case or control group individuals are separately matched with the amino acid sequence data, such as from polypeptides or proteins, of each of examined case or control group individual. For each such CNSP or CAASP various statistical measures of association with an examined phenotype are computed and reported.

Statements in the present application regarding the matching between the sequence data of examined individuals to CNSPs and CAASPs should not be taken to mean that the matching of CNSPs or CAASPs between different nucleic or amino acid sequences of the same person is not also possible. For example, the sequence data of malignant tissue of a person could be matched against the sequence data of non-malignant tissue of the same person. Thus, the derivation of CNSP or CAASP probes and the matching of the CNSP or CAASP relate to nucleic acid (DNA or RNA) or amino acid sequence data rather than to different individuals. However, typically the matching is between the sequence data of individuals expressing an examined disease or trait phenotype and the sequence data of different individuals that do not express the same phenotype, and this is the context in which the present application is explained.

Also, whereas the term “individual” is ordinarily used in the present application to refer to a person the methods described herein can be applied to sequences of nucleic (DNA or RNA) or amino acid from any organism. Also the use of the terms “case group” and “control group” are intended to distinguish between two groups, one that expresses a phenotype and another that does not express the same phenotype.

The application, thus, pertains, inter alia, to methods of deriving each CSNP of a particular sequence length from two to ninety-nine from digitalized data of single-letter nts of examined individuals in the normal 5′-3′ direction on nucleic acid sequences, such as chromosomes or genes, and of deriving each CAASP of a particular length from two to ninety-nine from digitalized data of single-letter amino acids of examined individuals in the normal C-to-N terminus direction on amino acid sequences such as polypeptides, of distinguishing between the sequences of case group individuals that express a phenotype and control group individuals that do not express the phenotype, of computing several measures of association that establish whether the CSNP or CAASP occurs disproportionally on the sequence data of individuals that express a phenotype relative to individuals that do not, and of reporting the resulting measures of association based largely upon the case and control group occurrence frequencies for each CNSP or CAASP by processes that allow the computer user to select for reporting the range of values of various statistical measures of association, such as the relative risk (RR), chi square (x2), and correlation coefficient (r2), as well as reporting in various ways such as alphabetically by CNSP or CAASP with related statistic, by statistical value with related CNSP or CAASP, or by CNSP or CAASP in the order that CNSPs or CASSPs occur on chromosomes or polypeptides with the related statistic.

The applicant is not aware of any prior art, association studies, or patents that report association measures such as the RR, x2, and r2 for contiguous amino acid sequence polymorphisms as are reported herein and, accordingly, believe that such associations are a matter of first impression. This application's amino acid associations are, however, similar in most respects to the nucleic acid associations, except for the additional step for the amino acid associations of translating nt-triplet sequences in the coding regions of protein genes into single-letter IUPAC amino acid sequences using instructions in a computer subroutine that return the cognate amino acid for each nt-triplet in accord with the canonical genetic code. Many of the aspects of this application that are explained in the context of CNSPs also apply to CAASPs but are are left unstated for CAASPs to avoid repetition since for the most part the methods for segmenting, sectioning, detecting, associating, and reporting CNSPs are the same for the single-letter CAASPs as they are for the single-letter CNSPs.

The CNSP and CAASP methodology described by the present application for associating genotypes to phenotypes differs in numerous respects from the single nucleotide polymorphism (SNP) genome-wide association study (GWAS) methodology which is presently the prevailing form of art for associating genotypes to phenotypes. SNPs involve single nucleotide (nt) polymorphisms for which a different nt base allele occurs at the same, single, nt location (i.e. locus) on homologous chromosomes, such as at the same locus on chromosome Number 1 of different individuals, or at the same locus on the homologous chromosome Number 1 that a person receives from his or her male parent and on the homologous chromosome Number 1 that a person receives from his or her female parent. Each person has 46 chromosomes consisting of 23 pairs of homologous chromosomes. These chromosomes range in size from about 250 million nucleotides in a single contiguous sequence on chromosome Number 1 to about a 58 million contiguous nucleotides on the Y chromosome. The total number of nt base pairs on a person's 46 homologous chromosomes exceeds six (6) billion, with about three (3) billion from the 23 chromosomes from the male parent and about three (3) billion from the 23 chromosomes from the female parent.

The SNP GWAS methodology became commonplace in the past two decades with the completion of the international HapMap project which cataloged millions of common SNPs in the human population, and with the development of DNA microarray assays that can presently detect associations for more than a million different SNPs of an individual at once. SNPs are commonly used in GWAS and in studies of smaller segments of the genome such as exome-wide studies. As noted by Altshuler and McCarrol, an indispensable starting point for SNP association studies was the acquisition of basic knowledge about SNP variation on the homologous chromosomes present in the human population, namely the identity of the SNP alleles themselves at a single locus on homologous chromosomes, the allele-specific frequencies in the population, and the SNP locations themselves, which they note was accomplished to a significant degree by the development of the HapMap reference database. They further note that the HapMap database enabled researchers and technology companies to design nucleic acid microarray assays for SNPs of interest from the database. McCarrol S. A. & Altshuler D. M., (2007) Nature Genetics Supplement, v39, doi:10.1038/ng2080. Similarly, the Wellcome Trust Consortium states that the two major events advancing SNP GWA studies were, first the International HapMap resource which documents patterns of SNP variation genome-wide and, second the availability of dense microarray genotyping assays containing sets of hundreds of thousands of single nucleotide polymorphisms. “Genome-wide association study of 14,000 cases of seven common diseases and 3,000 shared controls” (2007) Nature v447, 661.

SNP GWAS studies typically compare selected SNPs from the HapMap catalog with biological samples of nucleic acids of examined case and control group individuals using microarray assays. For example, the Illumina company's microarrays are based almost entirely on haplotype-tagging SNPs “tagSNPs” identified by the International HapMap Consortium. “SNP genotyping: six technologies that keyed a revolution” (2008) Perkel, J. Nature Methods, v5 No. 5, 448. TagSNPs are SNPs that are representative of a group of SNPs that are typically located near one another on the same chromosome, enabling the association of the representative tagSNP alone to implicate the particular chromosome and the SNPs at a particular region on the chromosome within linkage disequilibrium of the tagSNP with the expression of the phenotype.

SNPs are often reported to comprise the vast majority, typically estimated at 90%, of the nucleic acid polymorphisms in the genome of each person. The nt alleles for nearly each of the billions of loci in the human genome are heterozygous (i.e. have different nt base alleles) on homologous chromosomes for some people with respect to other members of the human population. In the context of SNP GWAS, heterozygosity is also referred to as polymorphism. In a recent study involving 14,002 people one in seventeen loci in the coding sections of examined genes was heterozygous. But most of these polymorphisms were very rare, with the variance from the normal allele at a particular locus often occurring for only one of the 14,002 examined individuals. “An Abundance of Rare Functional Variants in 202 Drug Target Genes Sequences in 14,002 People” (2012) Science: doi:10:1126/Science/1217826.

Most SNP GWA studies involve a sample drawn predominantly from “common” SNPs, which are defined to consist of SNPs for which the lesser-occurring allele at a locus occurs for more than five percent of the examined individuals. The vast majority of SNPs at a locus involve only two different alleles, but in theory any of the four DNA nt bases (i.e. A, T, C, and G) could occur at any given locus. The common SNPs occur only about once for every one thousand nts, or for about one-tenth of one percent of the total nts on a chromosome or gene. “Genetic Mapping in Human Disease” Altshuler, D., Daly, M., and Lander, E. Science. (2008); 322(5903): 881-888. doi:10.1126/science.1156409.

The practice of comparing SNPs from the HapMap catalog, or from other publicly available reference data sets, with the same locus on the homologous chromosomes of each case and control group individual examined for a study has the potential for stratification effects given the limited genetic diversity, as compared to the diversity in the population at large, represented by the HapMap catalog reference dataset and other reference datasets. This limited diversity occurs largely because the SNPs for the initial HapMap project involved only 270 individuals, and although additional HapMap studies and non-HapMap studies have since been conducted these also have involved only a few hundred individuals. Bush W S, Moore J H (2012) Chapter 11: Genome-Wide Association Studies. PLoS Comput Biol 8(12):e1002822. doi:10.1371/journal.pcbi.1002822. The “1,000 Genomes Project” which provides possibly the largest of the references datasets, now includes SNPs from a couple thousand individuals. But compared to the approximately seven billion people world-wide the reference database approach falls far short of cataloging human diversity.

In contrast to the SNP methodology the CNSP and CAASP methodology does not start with an a priori catalog of SNPs or reference polymorphisms that are compared with each case and each control individual. Instead, the present method associates CNSPs and CAASPs that are derived from only the case and control individuals that are themselves examined for a particular CNSP or CAASP study. In this manner the genetic variation specific to particular geographic or ethnic groups can be identified by selecting individuals from particular geographic or ethnic groups for a CNSP or CAASP study. Additionally, by not relying upon a catalog of variation from a small number of people, such as the 270 people examined for the initial HapMap project or even the couple thousand people examined by the 1,000 Genome Project, it is possible to identify variants that may be related to disease etiology which only occur in subgroups of the population that have not been reported in the reference sets. A majority of GWAS and other genetic studies have been limited to European ancestry populations, whereas genetic variation is greatest in populations of recent African ancestry. “Finding the missing heritability of complex diseases.” Manolio T., Collins F. et al. Nature 2009 October 8; 461(7265):747-753. The present application is the first to compare CNSP and CAASP probes consisting of each of the contiguous nucleic or amino acid sequence polymorphisms of a particular length 2 to 99 from the sequence data of the examined case and control group individuals themselves with the sequence data, such as chromosomes or polypeptides, of each of the examined case and control group individuals separately for association statistics. This contrasts with SNP GWAS where HapMap and other reference database SNP probes, not derived from the particular individuals studied for the SNP GWAS, are compared with both the examined case and control individuals to obtain the number of case and control group sequence matches for association.

There are only a few reference databases, and a paucity of individuals were examined to derive the SNPs for these databases, because the preparation of these databases requires the alignment of the homologous chromosomes of individuals with one another to detect allelic heterozygosity. Alignment is an inexact and labor intensive process when more than a few sequences are involved. Liu Q. et al. BMC Genomics 2012, 13(Suppl 8):S8 http://www.biomedcentral.com/1471-2164/13/S8/S8. The present application is the first to enable detection of variants related to disease etiology without first aligning homologous chromosomes.

Many patents cite to specific loci that have been reported in the scientific literature as correlated with the expression of a particular disease or trait phenotype, and then cite a SNP microarray assay test to ascertain whether these loci occur on the chromosomes of examined individuals. See e.g. Genetic markers for risk of atrial fibrillation, U.S. Pat. No. 8,795,963 (2014). Similarly, the Abstract of patent application 20080131887, (Jun. 5, 2008) “Genetic Analysis Systems and Methods” states that it “provides methods of assessing an individual's genotype correlations by analyzing the individual's genomic profile to a database of medically relevant genetic variations that have been established to correlate to a phenotype” and that “the genotype correlations are correlations of single nucleotide polymorphisms to diseases and conditions.”

Some patents also indicate that they further explain something about the implicated phenotype. U.S. Pat. No. 8,700,337 “Method and system for computing and integrating genetic and environmental health risks for a personal genome” for example indicates that it involves “determining etiological connections between diseases for which the individual has been determined to have a genetic risk.” Thus, prior art often compares genotypes to some external database of correlations or risk factors, reciting that previous findings have identified a relationship that it detects. In contrast, the present CNSP methodology does not rely on a priori published reports of known relationships between specific loci and a disease or phenotype. Instead, the present method itself establishes the associations of each CNSP or CASSP of a particular length from 2 to 99 with examined phenotypes rather than citing to previous SNP GWAS findings. The ability of SNP GWAS to detect etiological connections between disease and genotype is further vastly limited in comparison to the methods of the present application as demonstrated herein.

The present CNSP methodology, which is the first to detect and associate literally each contiguous nucleotide sequence polymorphism on chromosomes or genes with phenotypes, employs a different means of identifying polymorphisms for association than the SNP method. The present application uses digital sequence data of the individuals examined for a particular study to detect whether the nucleic or amino acid sequences of examined individuals, from chromosomes or polypeptides, match the digital CSNP or CAASP probes. In contrast, SNPs are detected using DNA microarray probes whereby a biological sample of an individual's molecular nucleic acid sequences are chemically hybridized to complementary Watson-Crick (W-C) (i.e. A-T/U, C-G) nucleic acid probes. For example, the Illumina company microarrays frequently use probes that consist of a sequence of nts that is 50 nts in lengths, i.e. 50-mer oligonucleotides, whereas the market-leader Affymetrix often uses 25-mer oligos, and the Agilient company's standard-length probe is a 60-mer oligo. “SNP genotyping: six technologies that keyed a revolution” 2008 Perkel, J. Nature Methods, V.5 No. 5, 448. LeProust E., Peck B., Spirin K., McCuen H., Moore B. Namsaraev E. and Caruthers M. “Synthesis of high-quality libraries of long (150mer) oligonucleotides by a novel depurination controlled process.” (2010) Nucleic Acids Research, v38, No. 8, 2522-2540 (doi:10.1093/nar/gkq163).

The present CNSP method detects polymorphisms through computer-implemented methods, where the digital CNSP or CAASP probes are “Perl regular expressions.” Perl is a computer-programming language. A Perl regular expression is a short sequence of text that is matched to a larger sequence of text. For the present application the text that is matched to the CNSP or CAASP regular expression is digital nucleic or amino acid sequence data representing the sequence of nucleic or amino acids on individuals' chromosomes/genes or polypeptides. An advantage of detecting polymorphisms within sequence data with CNSP or CAASP regular expression probes, as opposed to matching biological sequences to microarray probes, is that with regular expressions an exact W-C complementarity match for each locus of the regular expression does not always have to be present among the sequence data of examined individuals for the sequence on the examined individual's chromosome or polypeptide to match the probe and be counted for association statistics. Although by default only exact matches to the regular expression are found, the regular expression can be altered to contain pattern matching operators for certain letters of the regular expression that match any letter of the sequence data that is compared to it, or the regular expression can contain character class operators that permit specified groups of letters of the compared sequence data to match, or contain expressions that allow the compared sequence to have defined or open numbers of letters between segments of the regular expression, and a vast number of other parameters for matching different permutations. Thus, the digital CNSP and CAASP probes for the present method can match not only an individual's sequence data exactly as is the case for nucleic acid microarray probes but CNSP and CAASP probes can match a myriad of other designated permutations within the confines of the contiguous nts or amino acids of the digital probes. This greatly expands the search capability of the CNSP method over the SNP microarray techniques, and aids in ferreting out particular subsections of the CSNP or CAASP that are most associated with phenotypic expression.

Another practical aspect of using digital sequence data as contrasted with biological sequences is that its is easier to group together digital data from different studies to obtain studies that have the statistical power to detect rarely occurring variants, and also easier to alter the experimental design to remove individuals from a study to control for characteristics of individuals both physical and behavioral. Also, the storage and set up costs for digital data is less than for biological samples. Further, the cost of the use of a computer for running the digital analyses for the present application is minimal in comparison with the significant costs of running microarray assays.

The nucleic acid probes for microarray assays, which are nt templates that are compared against the nts from examined individuals' biological samples to determine if the sequence of the nucleic acid probe occurs on the individual's biological sample, typically consist of oligonucleotides in lengths from about 20 to 70 nts. “A comparative analysis of existing oligonucleotide selection algorithms for microarray technology.” Adebiyi, E. (2007) African Journal of Biotechnology v6, (13), 1582-1586. These probes, as noted, are often largely derived from HapMap tagSNPs, and consensus sequences for which the minor allele frequency of nts is less than one percent adjacent to the tagSNPs. For microarray probes a Watson-Crick complementary match of each of the 20 to 70 nts of the microarray probe with the nts of the biological sample is needed for hybridization of the sample to the probe to occur. Hybridization is typically detected by laser scanners and then counted by intensity signals for association statistics. U.S. Pat. No. 8,796,182 captioned “Genetic markers associated with risk of diabetes mellitus” which involves SNPs detected using microarray assays states in this regard that that “the presence of a specific marker allele can be indicated by sequence-specific hybridization of a nucleic acid probe specific for the particular allele” and that “probes or primers are oligonucleotides that hybridize in a base-specific manner to a complementary strand of a nucleic acid molecule. . . . If specific hybridization occurs between the nucleic acid probe and the nucleic acid in the test sample, then the sample contains the allele that is complementary to the nucleotide that is present in the nucleic acid probe. A probe or primer comprises a region of nucleotide sequence that hybridizes to at least about 15, typically about 20-25, and in certain embodiments about 40, 50 or 75, consecutive nucleotides of a nucleic acid molecule.” The use of SNP probes for microarrays assays which only reflect a single sequence reduces the reliability and validity of SNP GWAS statistical results and observed heritability over that which can be obtained from using the comprehensive CNSP method which associates literally every sequence of the given length that occurs among examined individuals.

A premise for matching DNA samples of examined individuals to microarray probes is that the probe sequence is homozygous for individuals in the population other than at the SNP location which is heterozygous. But there is substantial variability in the population, including rare variants, that may be present for the individuals examined for a particular study that is not present for the single reference sequence used for the microarray probe. For microarray assays the microarray probe will only hybridize to an individual's nucleic acid sample when each nt of the sample has a Watson-Crick match to a nt on the probe. But the nt samples of examined case group individuals with the same allele at the SNP locus as individuals whose samples hybridize but different alleles than on the probe at loci other than at the SNP locus will not hybridize because not every nt on these non-hybridizing samples has a Watson-Crick complement on the probe. This occurs without regard to whether or not the non-complementary nts on the chromosomes of non-hybridizing individuals relate to the expression of the examined phenotype. Thus, microarray assay results would indicate that the sampled sequence with a different allele at other than the SNP locus does not match the reference SNP probe, counting the non-matching sample as not implicated with the phenotypic expression targeted by the reference SNP even though the allelic difference that causes the sample to not match the probe may not have any effect on the expression of the examined phenotype, and the non-matching sample may be as highly correlated with the expression of the examined phenotype as the reference SNP.

A severe limitation of the microarray hybridization technique is that it only detects matches for the few sequences selected for probes, thereby failing to examine about 99.9 percent of the sequences on examined individuals' samples. The CNSP method overcomes this problems by associating literally every CNSP of a particular length that occurs among the examined chromosomes/genes of case and control group individuals with the expression of the examined phenotype by determining whether literally every CNSP occurs disproportionally for case as opposed to control group individuals. The CNSP method does not rely on a single fixed sequence for matching to the probe as does the microarray assay. Even though microarrays can include up to a couple million different probes for a single assay this number captures only a small fraction of the genetic diversity present in the human population.

The SNP approach, which defines a polymorphism based on the difference between nt base alleles at the same locus on different homologous chromosomes, requires the alignment of the sequences of nts on homologous chromosomes to ascertain whether there is a difference in nt base allele at the same locus on homologous chromosomes. Liu Q. et al. BMC Genomics 2012, 13 (Suppl 8):S8 http://www.biomedcentral.com/1471-2164/13/S8/S8. The alignment of multiple sequences is inherently time consuming and cannot be done with a high degree of accuracy simultaneously for large numbers of sequences because alignment requires the scoring of locus number and allele identity as to concordance on homologous chromosomes, and alignment is thrown off by insertions, deletions, translocations, repeats, and other structural variants that affect locus number and sequence length, which are now know to be far more common in the genome than thought just a few years ago. “Statistical aspects of discerning indel-type structural variation via DNA sequence alignment.” Wendl, M. & Wilson, R. BMC Genomics 2009, 10:359 doi:10.1186/1471-2164-10-359. For example, it took the international HapMap project team of scientists about three years to align the sequences of 270 individuals from Europe, Asia, and West Africa and to generate the initial HapMap catalog of common SNPs. This project genotyped about one million common SNPs by 2005 and more than three million by 2007. “Genetic Mapping in Human Disease” Altshuler, D., Daly, M., and Lander, E. Science, (2008); 322(5903): 881-888. doi:10.1126/science.1156409.

The CNSP methodology does not align homologous chromosomes because the CNSP methodology identifies CNSPs along the length of a single chromosome of a single individual, rather than identifying polymorphisms based on the alignment of different homologous chromosomes with one another at single loci so as to pick out allelic differences at a single locus on different homologous chromosomes as is done for SNPs. The CNSP methodology involves the first instance of the identification of each polymorphism for association in the 5′-3′ order along the length of a single chromosome of a single individual. The present methodology is also the first method to associate nucleic acid polymorphisms with phenotypes without aligning homologous chromosomes. The present methodology discerns differences between case and control group individuals by combining all of the CNSPs or CAASPs of all individuals examined by the study and comparing each CNSP or CAASP from this aggregate against the sequence data from chromosomes or polypeptides of each individual separately, so as to detect the number of case and control group sequences on which each such CNSP or CAASP occurs.

Broadly speaking the reporting of statistical associations between nt polymorphisms and phenotypes is not new. Many hundreds of patents have been issued for microarray methods employed in determining the degree to which nt sequences occur on case group individuals chosen for examination that express an examined phenotype relative to control group individuals that do not express the phenotype. U.S. Pat. No. 6,850,846, for example, lists well over a thousand patents involving microarray technologies related to the detection of nt polymorphisms and for software involved in applications relating to polymorphism detection and quantification. See also, U.S. Pat. No. 7,280,922 “System, method, and computer software for genotyping analysis and identification of allelic imbalance.” The present CNSP method, like the microarray probe arrays identified in U.S. Pat. No. 6,850,846, detects nt polymorphisms by use of probe sequences in various oligonucleotide lengths. But there is a major structural difference between the present method and microarrays. Microarray assays use biological and molecular probes whereas the CNSP probe is digital.

In the past decade about 4,000 U.S. patents have been reported for the prevailing prior art involving the association of SNPs with a phenotype, as revealed by a search of a USPTO database for the phrase “single nucleotide polymorphisms.” There are, however, significant structural differences between SNPs and CNSPs as well as significant differences in the means by which SNPs and CNSPs are detected and associated. One of the more obvious structural differences between SNPs and CNSPs is that SNPs involve a single nt locus where CNSPs involve multiple contiguous nts in a sequence of loci. SNP polymorphisms are detected by identifying the occurrence of different nt base alleles at the same single nt locus along among multiple homologous. CNSP polymorphisms are detected by first identifying multiple contiguous nucleotide loci of a given length along a single chromosome, or a subset of a chromosome such as a gene, of a single individual. For example, the seven-nt sequence GATTACA would have five CNSPs with a particular sequence length of three nts each, namely (1) GAT, (2) TAC, (3) ATT (4) ACA, and (5) TTA. The CNSP method is the first to identify polymorphisms for association in this manner. Then for the CNSP method the individual-specific CNSPs of all of the individuals examined for a CNSP study, from both case and control groups, are combined to ascertain study-specific CNSPs. These study-specific CNSPs are then each associated with the differential expression of the phenotype between case and control group individuals by matching each such CNSP with the sequence data of each individual separately and combining the total of case group individuals on which the CNSP occurs and does not occur as well as combining the total of control group individuals on which the CNSP occurs and does not occur for association statistics.

U.S. Pat. No. 7,974,789 “Genetic diagnosis using multiple sequence variant analysis” involves “algorithms and computer programs for revealing the structure of genetic variation” in which the Summary of the Invention and Abstract indicate that “the structure can be revealed with the use of any data set of genetic variants from a particular locus.” The term “polymorphism” is defined by U.S. Pat. No. 7,974,789, as it typically is, to connote a difference in nt base allelic representation between homologous chromosomes at a single locus, as follows “The term ‘polymorphism’ as used herein, refers to a condition in which two or more different nucleotide sequences can exist at a particular locus in DNA. Polymorphisms can serve as genetic markers.” U.S. Pat. No. 7,974,789 clusters together allelic polymorphisms which occur for common SNPs about once for every one-thousand nts in a sequence of contiguous nucleotides on chromosomes, and refers to such clusters as “sequence polymorphisms, adjacent polymorphisms, or contiguous polymorphisms,” even though the SNP nt components of these clusters are typically thousands of nts apart from one another on chromosomes. Further, U.S. Pat. No. 7,974,789 states “The present invention is based on the recognition that patterns of genetic variation at a locus are formed by clusters of interspersed polymorphisms that exhibit strong linkage. . . . These groups of polymorphisms are herein named Sequence Polymorphism Clusters (SPC).” A major difference between the CNSP method and this patent is that the CNSP nucleotide sequence polymorphism consists of a sequence of nucleotides that occur on consecutively numbered loci on chromosomes, whereas the U.S. Pat. No. 7,974,789 reference to “sequence polymorphisms, adjacent polymorphisms, or contiguous polymorphisms” denotes a sequence of nucleotides that are typically separated by thousands of loci from one another on a chromosome.

Another major difference between the CNSP method and this patent is that the CNSP method identifies and associates each CNSP on a chromosome or gene whereas, in contrast, U.S. Pat. No. 7,974,789 associates exceedingly few of the nts on a chromosome or gene. U.S. Pat. No. 7,974,789 states “the number of genetic markers should be kept as small as possible so that such studies can be applied in large cohorts at an affordable cost. Thus, an important analytical challenge is to identify the minimal set of SNPs with maximum total relevant information. . . . Multi-SNP haplotypes have been proposed as more efficient and informative genetic markers than individual SNPs.” Thus, whereas the challenge for U.S. Pat. No. 7,974,789 is to identify the minimal number of nucleotides from a chromosome or gene sequence to associate with a phenotype, the present CNSP method associates literally every nt sequence of a particular length from 2 to 99 with the phenotype.

Additionally, the SNPs examined by SNP GWAS studies are rarely the causal variants most highly implicated with the expression of a phenotype. SNPs are selected because of a difference in allelic representation at the same locus on homologous chromosomes rather than because they are the sequence variants most highly implicated with the expression of a phenotype. Although nearly all phenotypes are the products of both nature and nurture, many phenotypes have a large genetic component, often computed from studies of identical twins. The statistically significant associations found in GWA studies, however, rarely explain more than a small proportion of phenotypic variation or heritability. One of the many reasons provided for the missing heritability observed from SNP GWAS is that SNPs are correlated with unobserved causal genetic variants for the phenotypes but are unlikely to be the causal variants themselves. Thus, the causal variants, if located, would display more robust measures of association and heritability than the SNPs implicated by GWAS. Stringer S., Wray N. R., Kahn R. S., Derks E. M. (2011) “Underestimated Effect Sizes in GWAS: Fundamental Limitations of Single SNP Analysis for Dichotomous Phenotypes.” PLoS ONE 6(11):e27964. Doi:10.1371/journal.pone. 0027964. The CNSP method is believed to explain more heritability than the SNP microarray methods because of the CNSP method's vastly greater coverage, in terms of the number of nts on examined individuals' chromosomes that are associated with the phenotype, a difference of more than one-hundred fold, from the association of less than one percent of the nts on chromosomes or genes using prevailing SNP and structural variant methods to one-hundred percent using the CNSP method. Furthermore, by associating literally every polymorphism of a given length on an examined individual's chromosomes the CNSP method can then list the relative risk (RR), chi square (x2), and correlation (r2) measures of association for each CNSP without interruption along the chromosome in the order that the CNSP occurs on the individual's chromosome, thereby focusing in on the exact locations of each of the variants most highly correlated with the examined phenotype. The CSNP and CASSP method is the first to associate every polymorphism of a given length on chromosomes or polypeptides with an examined phenotype, and the first to list measures of association continuously without interruption along the chromosomes or polypeptides from their beginning to end.

In the past two decades genome-wide association studies have identified nearly 800 single-nucleotide polymorphisms (SNPs) for which the disparity between case and control group occurrence is highly significant statistically (at the p<5×10̂−8 level). “Genomewide Association Studies and Assessment of the Risk of Disease” Manolio, T. N Engl J Med 2010; 363:166-76. Despite the magnitude of these findings only a handful of these studies have been followed-up in an attempt to locate the biological mechanisms underlying their occurrence because of the difficulty of locating causal variants in the regions implicated by the SNP methodology. SNP methods implicate regions typically within tens of thousands to one-hundred thousand nts of the most highly implicated causal variants. “Genomewide Association Studies and Human Disease,” Hardy, J. and Singleton, A. N Engl J Med. (2009) 360(17): 1759-1768. doi:10. 1056/NEJMra0808700. “Genetic Mapping in Human Disease” Altshuler, D., Daly, M., and Lander, E. Science. (2008). The regions of the chromosome implicated by the SNP methodology for the location of the causal variants for the phenotype are too large for the time-consuming and exacting biochemical and metabolic analyses of specific loci needed to establish the underlying biological mechanisms for the expression of phenotype.

Despite the value of the SNP methodology in locating the vicinity of genomic variants that may be causing disease, few of the SNPs identified in genome-wide association studies have clear functional implications that are relevant to mechanisms of disease. What is becoming clear from these early attempts at genetically based risk assessment using SNPs is that currently known SNPs explain too little about the risk of disease occurrence to be of clinically useful predictive value. One of the reasons for the inability to locate causal variants is that the regions implicated by the findings of SNP GWAS, covering ten thousand to one-hundred thousand nucleotides, i.e. regions of 10 kb to 100 kb, are too large to systematically explore the underlying metabolic and biological bases. Narrowing an implicated locus to variants that directly cause susceptibility to disease by disrupting the expression or function of a gene, or by some other functional effect, has proven elusive to date. This will be a key step in improving our understanding of the mechanisms of disease and in designing effective strategies for risk assessment and treatment. “Genomewide Association Studies and Assessment of the Risk of Disease” Manolio, T. N Engl J Med 2010; 363:166-76.

The inability of the SNP GWAS method, which associates less than one percent of the nucleotides on chromosomes or genes with a phenotype, notably excluding rare variants, to identify the causal variants of disease, calls into question the efficacy of the SNP methodology. The low heritability of the significantly associated SNPs that have been reported in the previous decades has focused attention on the role of rare genetic variants, for which the minor allele at a SNP locus occurs in less than one percent (1%) of the individuals sampled. Rare variants are excluded by the SNP microarray method since the SNP probes for GWAS studies are typically based on common SNPs from reference databases. The CNSP and CAASP methodology is especially adept at identifying rare variants that occur for less than one percent of the population since the CNSP and CAASP methodology identifies each variant or polymorphism of a given sequence length.

U.S. Patent Application 20130296178, “Methods for Genetic Analysis” asserts that “Many argue that genetic testing for common multifactorial traits (e.g. diseases) will not be useful in practice due to the incomplete penetrance and low individual contribution of each gene involved (Holtzman and Marteau, 2000; Vineis et al. 2001). However, these arguments are based in large part on the use of single loci to predict whether or not an individual will exhibit the trait (Beaudet 1999; Evans et al. 2001). What is needed is a reliable approach for determining an individual's risk of developing or exhibiting a multifactorial trait that is based on the individual's genotype at a plurality of loci, each of which are factors in the manifestation of the multifactorial trait.” However, epistatic relationships involving a plurality of loci, sequences, and gene interactions can be only be sparsely described with the SNP method because of the scant coverage of SNP associations, at about one-tenth of one percent. The CNSP and CAASP methodology, in contrast, is especially adept at discerning epistatic relationships since it identifies each variant at the particular length.

### BRIEF SUMMARY OF THE INVENTION

The English word “cusp” is defined as a point that marks the beginning of something new, as in the phrase “on the cusp of a new era.” The CNSP and CAASP contiguous sequence polymorphism method, collectively the “CSP” method, ushers in a new era in the association of genotypes to phenotypes because it associates literally every nucleic or amino acid sequence polymorphism of a particular length that occurs on chromosomes or polypeptides of examined individuals, thereby identifying not only the particular polymorphisms that are most highly associated with phenotypic expression but also identifying the order and location with which these polymorphisms occur on chromosomes or polypeptides.

The CSP method marks a transition from the use of biological and molecular probes on microarrays for comparison with biological samples of nts from examined individuals for the association of genotypes to phenotypes, to the use of digital probes for comparison with the nt or amino acid sequence data of examined individuals for association studies. In the previous decade nearly a thousand SNP GWAS have been published. The SNP method has been successful in directing attention to variants implicated with diseases. SNPs ordinarily correlate with regions of linkage disequilibrium varying from an estimated ten to one-hundred thousands nts in range. Only a handful of the SNP GWAS have lead to the identification of specific nucleic acid variants that have been physically linked to an underlying biological basis for an examined phenotype. The specificity of the method introduced by the present application, which provides exact statistical values for each variant of the particular sequence length, and orders the statistical values in the 5′-3′ or C-to-N terminus order that the associated CNSP or CAASP occurs on chromosomes or polypeptides occurs thereby indicating the exact location of the variants that have the greatest correlation with disease phenotype, has the potential to reveal causal variants for disease to a degree not previously possible.

Although the specific-identification aspect of the CNSP and CAASP method enables the reporting of statistical measures of association for literally every sequence variant at the particular length, ordinarily the method would be used to report only small subsets from within the full range of variants at the particular sequence length, such as only the CNSPs or CAASPs that are highly correlated with the expression of the disease or trait phenotype. This is because the present method provides the user of the method with the ability to examine only those results, from the totality of all computations of the statistical measures of association, that meet the range of values selected by the user—such as only the needle-in-the-haystack associations at a desired level of significance or correlation—for display to the computer monitor and for copying to a text “run report.”

Novel aspects of the present method include its vastly greater coverage in terms of the number of nts on chromosomes that can be associated, from less than one percent for SNPs to one hundred percent for CNSPs, the ability of the CNSP method to continuously order various measures of association in the 5′-3′ order that CNSPs occur on DNA sequences or the C-to-N terminus order that CAASPs occur on polypeptides, the ability of the CNSP method to obviate the need for aligning homologous chromosomes to establish probes for detection of sequence variants, the method's ability to discern variants endemic to sub-populations by comparing the polymorphisms of examined case group individuals with examined control group individuals as opposed to comparing both case and control group individuals with an a priori reference battery of HapMap SNPs derived from only a few hundred individuals, the ability of the CNSP method to account for rare variants which is not done with SNPs, as well as the ability of the CNSP method to consider the interactions of all polymorphisms with one another which is only possible after having associated literally every polymorphism from case and control individuals, and other reasons described herein.

### BRIEF DESCRIPTION OF THE SEVERAL VIEWS OF THE DRAWINGS

The present application does not contain any drawings. However, it does contain several figures. FIGS. 1 through 13, which appear at the end of the following Detailed Explanation of the Invention at pages 86 to 110 of the specification immediately preceding the claims, contain text and numbers in tabular form as well as excerpts from certain of the working examples. FIGS. 1 to 4 specify discrete steps employed for the working examples, specifically indicating the program instruction line numbers for the steps, the section of the run report in which the output from the steps is reported, and a brief comment describing the processes that are specified for execution by the computer at the line numbers of the Perl program for the step. FIG. 5 identifies sections of the run reports.

FIG. 6 computes the number of CAASs at particular lengths based on the computational formula, namely that “the number of segments of sequence data, with each segment having the same length, equals the length of the sequence data less the sequence length of the segment plus one.” FIG. 6 provides source sequence data for the aquifex aeolicus amino acid analysis working example consisting of the NCBI ending and beginning loci numbers for each of 24 amino-acyltRNA synthetase enzyme genes or gene subunits, based on the order of the amino acid, on the standard genetic code, that is aminoacylated by the aaRS enzyme genes, starting with the aaRS enzyme gene for phenyalanine. For example, the phenyalanine aaRS enzyme gene has an NCBI ending locus number of 657057 less an NCBI beginning locus number 656041 equal to 1,016, to which 1 is added resulting in 1,017. This is the number of nt NCSs, but is not the desired number of amino acid CAASs. To derive the number of CAAS it is necessary to divide the number of NCSs by three (1,017/3=339) and from this number is subtracted the CAASP particular sequence length for each of the lengths from two through ten. For the phenyalanine aaRS enzyme gene at CAASP length 2 there were (339 less 2=337) CAASs, at length 3 there were (339−3=336) CASSs, and at length 10 there were (339−10=329) CAASs (FIG. 6 pages 1 to 9). The number of CASSs for the sequence data of each of the 24 aaRS enzyme genes at each sequence length from two to ten is derived at FIG. 6. Also reported on FIG. 6 is the number of CAASs for the aggregate of all 24 aaRS enzyme genes at each particular length, and for all CAASs in the aggregate for lengths two through ten. The number of CAASs for each of the input 24 aaRS enzyme gene sequence data at each sequence length from two through ten, the aggregate number of CAASs at each length from two through ten, and the aggregate number for all lengths two through ten which is computed at FIG. 6 is also reported in the Section E run report. FIG. 7 consists of excerpts from the aquifex aeolicus Section E working example run report. The reconciliation of the computational formula at FIG. 6 to the FIG. 7 Section E run report demonstrates that the present application captures literally each CNS and CAAS of a particular length for input sequence data.

### DETAILED DESCRIPTION OF THE INVENTION

The CNSP and CAASP method that is the subject of the present application involves inputting digital sequences of nucleic or amino acid data in single-letter text format, as are commonly stored in computer files, into the permanent memory devices of a computer. The computer used to prepare the four working examples of the invention that are appended to the present application was an IBM PC with the Microsoft Windows operating system for the processing of digital information, but other computer operating systems and platforms such as MacIntosh and Unix could also have been used. The instructions for processing the CNSP and CAASP methods were prepared in the “Perl” computer programming language which was created in 1987. “Perl” is an acronym that stands for Practical Extraction and Report Language. For the working examples of the present application instructions from a Perl computer program were used to direct the computer to load, parse, sort, display, report, and otherwise manipulate the digital nucleic and amino acid sequence data that was input into data structures employed by the Perl computing language such as arrays, scalars, and associative arrays and stored on the computer's permanent memory devices. Only a single subroutine, that for converting nt-triplet sequences into cognate amino acids in accord with the canonical genetic code, was used. Otherwise the processing was linear by program line number. Versions of the Perl programming language are available for computer operating systems other than Windows, such as for MacIntosh and UNIX systems. Many computing languages other than Perl such as “C” could also have been used to prepare the computer programs.

In general, the CNSP and CAASP methodology for the present application involves the following steps. First, after inputting the nucleic or amino acid sequences of each case and control group individual the sequence data are segmented into sections each of the same given length, i.e. CNSs or CAASs, and duplicates of the same sequence at the particular length from the individual input sequence are removed retaining a single instance of each sequence-specific CNSP or CAASP.

Second, the CNSPs or CAASPs from each case and each control group individual sequence are combined together and duplicates of the same sequence from this aggregate are removed, retaining a single instance of each CNSP or CAASP at the given length from among the aggregate sequences of all case and control group individuals examined for the particular CNSP or CAASP study. Each of these CNSP or CAASP study-specific polymorphisms is then statistically associated with the phenotype by first detecting whether each such CNSP or CAASP sequence occurs on the nt or amino acid sequence data of each case or control group individual's sequence separately. Third, a sum of the number of case group sequences on which the CNSP or CAASP occurs and does not occur is made as well as a sum of the number of control group sequences on which the CNSP or CAASP occurs and does not occur. Various statistics of association for each CNSP or CAASP are computed based on the number of case and control group individuals on whose chromosomes/genes or polypeptides the CNSP or CAASP occurs and does not occur.

Fourth, the CNSP or CAASP are reported along with their associated statistics in several formats such as alphabetically by CNSP or CAASP followed by the computed statistical value, by statistical value followed by the CNSP or CAASP, and by CNSP or CAASP in the order that the CNSP occurs in the 5′-3′ direction on the chromosome/gene of case or control group individuals or in the order that the CAASP occurs in the C-to-N terminus direction on the polypeptide of case or control group individuals along with the associated RR, x2, or r2 beside the CNSP or CAASP. This listing runs continuously without interruption from the beginning to the end of the chromosome/gene or polypeptide sequence of a case or control individual.

The user of the CNSP and CAASP method selects the nt or amino acid sequence data of the case and control group individuals that are to be examined for the study. The user also selects which such individuals are classified as “case” group individuals that express the phenotype and which individuals are “control” group individuals that do not express the phenotype.

The user of the present CNSP and CAASP methodology also selects the particular length of the CNSP or CAASP that is examined, since the method examines only a single particular CNSP or CAASP length at a time. However, a single computer run of the method can process multiple designated sequence lengths for CNSPs or CAASPs seriatim if the user desires. The appended working examples associate lengths from two through ten in a single computer run and also report data that shows the progression of CNSP or CAASP base sequences from one length to succeeding lengths in addition to reporting the data regarding association statistics and the order along chromosomes or polypeptides of CNSPs or CAASPs.

Even though the CNSP and CAASP method can examine any sequence length for the CNSP or CAASP selected by the user, the present application claims only sequence lengths from two (2) through ninety-nine (99) since conventional nucleic acid microarray assays that compare an individual's biological nucleic acid sequences to biological nucleic acid probes for SNP GWAS, exome, and other association studies do not ordinarily use nucleic acid probes with sequence lengths greater than 100 nts. Current microarray assays, nonetheless, can use probe lengths up to 150 nts if special production techniques are employed in making the probes. LeProust E., Peck B., Spirin K., McCuen H., Moore B., Namsaraev E. and Caruthers M. “Synthesis of high-quality libraries of long (150mer) oligonucleotides by a novel depurination controlled process.” 2522-2540 Nucleic Acids Research, 2010, Vol. 38, No. 8; doi:10.1093/nar/gkq163). The present application's CNSP and CAASP methodology does not preempt the reporting of association data for nucleic or amino acid sequences at any of the claimed oligonucleotide lengths from 2 through 99 since existing microarray assays derive association statistics at the lengths claimed by the present application.

The user also selects the range of values of the computed association statistics for reporting. After the user designates the input parameters and the computer program is run the method reports only those associations that accord with the user's preferences by displaying the CNSP or CAASP and the associated statistics within the ranges specified by the user to the computer monitor and by copying to a Microsoft “notepad” text file which the user can save, if desired, using the notepad.

The number of contiguous nucleotide sequences (CNSs) of a particular sequence length within the input nucleic acid sequence of an examined individual equals the number of nts of the input nucleic acid sequence data, such as from chromosomes/genes or polypeptides less the number of nts of the particular length of the CNSP plus one. For example, if a gene had a sequence length of 1,500 nts and the particular length for the CNSP was 25, as has been a common oligonucleotide length for Affymetrix DNA probes for microarray assays, the total number of CNSs each 25 nts in length from this gene would be 1,476 (which equals the 1,500 nt sequence length of the gene less the particular length of the CNSP of 25, plus one). This reflects the fact that each of the nts of the 1,500 nt gene would start a CNS with a length of 25 except the last 24 nts of the gene.

It is not, however, the number of CNSs that are associated with the examined phenotype. Rather, it is the number of CNS “polymorphisms” i.e. CNSPs. The number of CNSPs equals the number of CNSs less the duplicate CNS sequences of the same length within the input DNA sequence. A 1,500 nt length gene would have 1,476 CNSs with a particular length of 25. The same 1,500 nt gene with a CNSP particular length of only two (2) nts (instead of 25) would have 1,499 CNSs with a length of two (i.e. 1,500−2+1), but no more than 16 CNSPs. There are only 16 different sequences two nts in length (i.e. 4×4=16). Therefore, assuming that all 16 different nt sequences two nts in length occur within the 1,500 nt gene occur, the number of CNSPs would be 16 as well as the number of associations. However, for CNSPs of a higher particular length, e.g. ten, there are many more than 16 possible CNSP sequences, i.e. four to the tenth power 4̂10=1,050,000 possible sequences, and the number of CNSPs asymptotically approaches the number of CNSs as the CNSP length increases since with increasing lengths there are fewer duplicates. A CNSP of a particular length of 25 has 4 to the power of 25 or 11,300,000,000,000 possible CNSP sequences. At a CNSP particular length of 25 the number of CNSPs can be expected to be very close, if not the same as, the number of CNSs for a 1,500 sequence gene. The distinctiveness of nt sequences at higher sequence lengths is responsible for the distinctiveness of hybridization for nucleic acid microarray assays, as well as the distinctiveness of the CNSP method, and this enables associations without considering the particular locus number for both the microarray analysis and the CNSP analysis. A microarray or CNSP probe of an appreciable sequence length can readily be matched against the case or control group individual's sequence data to locate the particular loci for the probe if desired.

Section E of the working examples of the CNSP and CAASP method specifically identifies both the number of CNSs and CAASs as well as the number of CNSPs and CAASPs for each particular CNSP or CAASP length examined. Since each CNSP is associated with the examined phenotype, the number of CNSPs equals the number of associations. For the chi square statistical measure of association the number of CNSPs is also the number for the Bonferroni adjustment for false positives based on repeated sampling from a single source. Since the number of CNSPs of the particular sequence length is identified at Section E of the run report the Bonferroni adjustment factor is also identified. The chi square value that is reported in the run report is not adjusted by the Bonferroni adjustment factor though doing so, if desired, involves the relatively straightforward exercise of dividing the desired level of probability for the analysis by the number of CNSPs and then ascertaining whether the computed chi square statistic reaches that level of statistical significance.

The following continues the example involving a 1,500 nt gene DNA sequence with a particular CNSP sequence length of 25 for the purpose of quantifying the difference in the number of nts in a 1,500 nt gene that are associated with an examined phenotype under the present CNSP methodology as opposed to prior art. Under prior art, involving the SNP microarray and structural variant methods, less than one percent of the nts of a DNA sequence on average would be associated with the examined disease or trait if literally every SNP and every structural variant (such as insertions, deletions, tandem repeats, copy number variants, etc.) within the sequence was associated. The one percent coverage is based on the ratio of the entire number of SNPs in the genome (here assuming about one SNP per 1,000 nts or about one-tenth of one percent of total nts in the DNA sequence) plus the total number of nts for structural variants estimated at two-tenths of one percent. “Gene copy-number polymorphism in nature.” Schnider D. R. and Hahn M., Proc. R Soc B (2010) 277, 3213-3211. At three-tenths of one percent coverage for a 1,500 gene sequence, there would be only 5 nts for association. But the actual number of probes on a SNP microarray is far less than the actual number of SNP variants that occur in nature so that the actual number of nts examined under the prevailing SNP method would ordinarily be much less than the 5 nts on average per 1,500 nts. In contrast, one-hundred percent of the CNSPs of a particular length are associated. For a 1,500 nt gene with a CNSP particular length of 25 about 1,476 CNSPs (more particularly 1,476 less the exceedingly few, if any, duplicate CNSs at the CNSP particular length of 25) each having a length of 25 would be associated with the examined phenotype.

But because the CNSPs are sequences of nts and not individual nts each nt in the chromosome/gene that is matched to the CNSP probe would ordinarily be involved in multiple CNSPs. All nt loci of the 1,500 gene, except the number equal to the CNSP particular length number less one at the beginning and end of the gene, are involved in a number of CNSs equal to the CNSP particular length. Assuming that there are no duplicates in a 1,500 nt gene with a 25-mer CNSP, the number of CNSs would equal the number of CNSPs. Then all CNSPs from the 1,500 nt gene sequence except the CNSPs equal to the CNSP particular length less one (i.e. 25−1=24) nts at the beginning of the examined 1,500 nt gene and the 24 nts at the end of the 1,500 nt gene, or 1,500−24−24=1,452 CNSPs for both beginning and ending, would be involved in 25 different CNSPs. Thus, 1,452 nts×25=36,300 nts would be involved in these 1,452 associations. In addition to these 1,452 associations there are also an additional 600 nts, equal to two times (i.e. beginning and end) the CNSP particular length less 1 times a decreasing succession from the CNSP length to one), i.e. 2(24*25/2)=(24*25)=600 (or more succinctly worded the number equal to the CNSP particular length times the CNSP particular length less one). Thus, a total number of 36,900 nts (i.e. 36,300 plus 600 nts) would be involved in associations for the example with the 1,500 nt gene having no duplicate CNSs with a 25-mer CNSP length. This figure (of 36,900 nts) reconciles with the total number of nts computed by multiplying the number of CNSs for the particular length, or 1,476, times the particular CNSP length of 25 (i.e. 1,476*25=36,900), and illustrates precisely the progression of CNS polymorphisms within a DNA sequence such as a 1,500 nt gene. The 36,900 nts associated with the phenotype as part of 1,476 CNSs each 25 nts in length from the 1,500 gene nt sequence provides far more coverage in terms of number of nts associated with the examined phenotype than the only about 5 nts or fewer that are associated under the SNP GWAS and prior art.

This progression of CNS polymorphisms can also be explained without numbers but spatially. First, take the entire input DNA sequence, such as a gene or chromosome, and segregate it into contiguous nts of the same length, (e.g. 25), by starting from the first locus position of the input DNA sequence and then continue in the 5′-3′ direction extracting each sequence of the defined length (e.g. 25) and once extracted read each extracted sequence into a data array. Continue doing this along the input DNA sequence until less than 25 nts remain in the input DNA sequence. Then return to the beginning of the input DNA sequence but this time instead of starting at the first locus position on the input DNA sequence start at the second locus position on the input DNA sequence and extract nts of the defined length putting each into the data array until less than 25 nts remain. Then return to beginning of the input DNA sequence but this time start at the third locus position extracting sequences of the defined length putting each into an array until less than the number of nts of the defined length (e.g. 25) remain in the input DNA sequence, and continue this for a number of times equal to the defined length (e.g. 25). This captures the total number of CNSs, which equal the input DNA sequence length less the defined length plus one, or 1,476 for CNSs each 25-mer in length from a 1,500 gene sequence.

While the above method gives the CNSs it doesn't give the CNSPs. CNSPs are CNSs with duplicates of the defined length removed. It is the CNSPs and not the CNSs that are associated with phenotypes. Thus, if there are multiple copies of the same CNS of a defined length within an input DNA sequence only a single instance of the CNS is associated with the phenotype. Thus, the alphabetical listings of associations for all CNSPs of a particular length from chromosome/gene sequence data would identify a particular CNS only once if it occurred several times within the chromosome/gene sequence. But it is not the case that only a single instance of a CNSP is reported when the relative risk (RR), chi square (x2), or correlation coefficient (r2) statistic of association is reported with the CNSP listed continuously along the chromosome/gene sequence in the order that the CNSP occurs on the sequence. For such reports if a particular CNSP occurs multiple times on an individual's chromosome/gene sequence the CNSP is listed each time it occurs on the chromosome/gene along with its associated statistic. If for the continuous reporting along the chromosome/gene the user selects for reporting only a range of a statistic, e.g. only RR>2.0 to RR>4.0 or r2>0.5 to r2>1.0, then an enumerated value is reported adjacent to the CNSP for only the statistics within the selected range, and for values that do not fall within the range adjacent to the CNSP along the chromosome/gene instead of an enumerated value for the statistic is reported the empty set, i.e. “( )”.

The present application pertains only to methods involving the use of digital nucleic and amino acid sequence data. The first full sequence of a gene of an organism was published in 1976, and the full sequence of the billions of base pairs of the human genome was published online in digital form in 2001. Fiers W., Contreras R, Duerinck F., Haegeman G., Iserentant D., Merregaert J. et al. (April 1976). “Complete nucleotide sequence of bacteriophage MS2 RNA: primary and secondary structure of the replicase gene”. Nature 260 (5551): 500-7. Lander E. S., Linton L. M., Birren B., Nusbaum C., Zody M. C., Baldwin J. et al. (February 2001). “Initial sequencing and analysis of the human genome”. Nature 409 (6822): 860-921.

The present application involves processes rather than a composition of matter. The process claims presented by the present application are not wholly directed to a “product of nature” because they relate to digital representations of nucleic and amino acids rather than to the nucleic and amino acid molecules themselves, and because of functional and other reasons, including that “a process claim is not subject to the markedly different analysis for nature based products used in the process.” 2014 Interim Guidance on Patent Subject Matter Eligibility, United States Patent and Trademark Office, 79 Fed. Reg. 74169, 74623 (Dec. 16, 2014).

The process claims of the present application differ from the claims in the case of Association for Molecular Pathology et al. v. Myriad Genetics, Inc., et al., 569 U.S. _, 133 S. Ct. 2107 (2013) (Myriad), for which Myriad sought the exclusive right to synthesize and use particular biological molecules, namely certain genes. The present application does not claim exclusive rights to the use of any genes, or any nucleic or amino acid sequences and, therefore, does not tie up the use of products of nature.

While the CNSP and CAASP method relies upon the full sequencing of the nucleic or amino acids from biological samples of examined individuals, it does not involve sequencing itself. Rather the method utilizes nucleic or amino acid sequence data which has been reduced into a digit computer text format consisting of the IUPAC single-letter nts (i.e. A, T, C, or G) or the IUPAC single-letter amino acids.

The present method involves novel methods for detecting sections of sequence data of case and control group individuals that match digital CNSP and CAASP probes, and for associating the sequences reflected by these probes with particular phenotypes based on the frequencies with the sequence data of case and control group individuals contain sections that match the probes. But there are other methodologies, such as DNA microarray methods, that are also able to make and report associations of probes in the 2 to 99 lengths claimed by the present application. Thus, the present application does not preempt the association of nucleic or amino acids with phenotypes.

The present method, however, differs in numerous respects from microarray methods. Microarrays use nucleic acid molecules as probes. Instead of nucleic acid molecular probes, the present application uses digital nucleic and amino acid sequence data as probes that have the form of a Perl regular expression. More particularly, the present application involves methods to segment digital data representing nucleic acid sequences from examined individuals into sections each the same length of nts called CNSPs, or to segment digital data representing amino acid sequences into sections each the same length of amino acids called CAASPs. It then associates and reports for each CNSP or CAASP various statistical measures based on the number of case and control group individuals on whose chromosome/gene or polypeptide sequence data the CNSP or CAASP occurs or does not occur.

CNSP or CAASP are derived based on their occurrence among the sequence data of a chromosome or polypeptide of at least one of the case or control group individuals examined for the particular CNSP or CAASP study, but for the contiguous sequence polymorphism methodology the CNSP or CAASP are the probes that are matched with the input sequence data of individuals for establishing associations as to whether the CNSP or CAASP occurs on each particular sequence data or not. If the process claims for the present application are considered to be directed to a “product of nature” they are markedly different from products of nature because of the difference in structure between nucleic or amino acid molecules and digital sequence data, because of differences in function between the sequence of naturally occurring nucleic or amino acid molecules and the digital CNSP and CAASP probes, and because of differences between the manner in which sequences of nucleic or amino acid molecules appear on chromosomes or polypeptides and how the CNSP and CAASP are reported for the present methodology.

The CNSP and CAASP are digital representations of nucleic or amino acid molecules but are not nucleic or amino acid molecules themselves. The CNSP and CAASP reside in various data structures employed by the Perl computing language, namely arrays, associative arrays, and scalars, that are stored in the permanent memory devices of a computer. Microarray probes only detect the nt sequences of the biological samples of examined individuals that are W-C complements of the microarray probes. But the digital CNSP and CAASP probes as Perl regular expressions return not only exact matches but can also return as matches from the sequence data of examined individuals that do not exactly conform to the sequences on examined individuals.

The various statistical measures of association that are computed separately for each CNSP or CAASP include the number and percentage of case and control group individuals on whose sequence data the CNSP occurs or on whose polypeptides the CAASP occurs, as well as the RR, x2, and r2. The association measures are reported in several formats selected by the computer user and displayed to the user's monitor as well as copied to a Microsoft “notepad” text file run report. The user of the CNSP or CAASP method selects the input nucleic or amino acid sequences and also selects the particular length for the CSNP or CAASP, as well as the range of values for each of the measures of association that are reported to the monitor and run report. The user, accordingly, may chose to report only the “needle-in-the-haystack” coefficients of correlation between the occurrence of the CNSP or CAASP and the expression of the phenotype such as only those CNSPs or CAASPs with a range of correlation coefficients between r2=>0.5 and r2=<1.0, or only CNSPs or CAASPs for which the chi square statistic reaches a level of significance of probability of the observed disparity between case and control group occurrence specified by the user (such as the standard Bonferroni adjusted <5×10̂−8), or case group occurrence percentage relative to control group occurrence percentage that exceeds a desired ratio (such as RR=>2.0). This ability to report only the needle-in-the-haystack CNSPs or CAASPs and statistics is especially valuable because the present application may generate thousands, millions, or many more associations, depending upon whether the CNSP or CAASP is matched to a gene, a chromosome, or a genome. Thus, the number of associations computed ordinarily exceeds the number that can be practicably examined by a person.

The computer user can also chose to have the statistical measures reported in various ways that do not occur in nature, such as alphabetically by CNSP and CAASP IUPAC single-letter designation followed by the selected statistical measure of association if the user wants to find the results for a particular CNSP or CAASP, or by value of the selected statistic followed by the CNSP or CAASP if the user wants to find the most highly significant or highest correlated CNSPs or CAASPs, or by CNSP or CAASP followed by the RR, x2, or R2 in the order that the CNSP or CAASP occurs on the chromosome/gene or polypeptide of case or control group individuals if the user wants to examine the value of a statistical measure as it occurs along the length of a chromosome or polypeptide.

The user can also select whether or not to list various input nucleic or amino acid diagnostic data such as whether to display to the monitor and text report the nucleic or amino acids of the input chromosome/gene or polypeptide sequence or some subset thereof, or whether to display the aggregate number of nucleic or amino acids on the input sequence data, or the number of particular nts (i.e. As, Ts, Cs, and Gs) or particular amino acids on the input sequence data. These diagnostic statistics are included in the method to enable confirmation that the source sequence data was properly input. They need not be reported each time a different computer run is made because they do not differ from one run to the next using the same input sequences. The same is true for the statistical measures. That is, they also do not differ from one run to the next run when the same parameters are set. Therefore, for the present application there is no issue regarding whether the results can be replicated from one run to the next such as exits with the results of microarray assays.

The Myriad Court found that cDNA, which is produced by removing from protein-coding genes the “introns” which do not code for amino acids thereby leaving only the “exons” which do code for amino acids, was patent-eligible because the sequence of the resulting cDNA sequence was markedly different from the naturally occurring DNA sequence. Thus, even though the remaining exons that comprise the cDNA have the exact sequence of DNA as the exon sections of the naturally occurring protein gene, and the exons in the cDNA are in the same order as they are in the naturally occurring protein gene sequence with only the intervening introns removed from the natural sequence, the cDNA has a sequence that is markedly different from the sequence of the naturally occurring protein gene and is, therefore, patent-eligible. Although CSNP and CAASP can be segments corresponding to a section of a naturally occurring nucleic or amino acid sequence from at least one of the studied individuals, they are not merely extracted from sequence data of examined individuals. Once extracted they are used as probes that return matching data products that are reported in various formats that do not correspond to that of naturally occurring sequences, including reporting alphabetically by CSNP single letter IUPAC designation (i.e. A, T, C or G) or single letter IUPAC amino acid designation along beside one of the various statistical measures of association for the CNSP or CAASP, or reporting by value of the statistic from highest to lowest along with the CNSP or CAASP, or by reporting by CNSP or CAASP in the order in which it occurs along the entire length of a chromosome or polypeptide of an individual along with the associated RR, x2, or r2 for the CNSP or CAASP. Moreover, these reports do not list all of the CNSPs or CAASPs if, as would normally be the case, the user prefers to view only selected results, and in this respect are like cDNA which excludes sections of naturally occurring sequences from the reported products. Also when the CNSPs or CAASPs are listed alphabetically or by statistical value from highest to lowest they are not reported in the same sequence as naturally occurring sequences of nts or amino acids on chromosomes or polypeptides. Also the CNSP and CAASP are not listed alone but are listed along with their statistical measures. Even when the CNSP or CAASP are listed in their natural order along a chromosome or polypeptide they are listed beside their associated statistic. Thus, the products of the CNSP and CAASP probes matches are reported in a manner that is markedly different than that of naturally occurring sequences.

In addition to the obvious structural differences between the CNSP and CAASP which are digital representations of nucleic and amino acid molecules rather than the molecules themselves, the CNSP and CAASP are used for a function different than that of naturally occurring nucleic or amino acid molecules. In particular, the CNSP and CAASP are digital probes, i.e. digital templates that are compared against the digital sequence data representing nts on chromosomes or digital sequences of amino acids on polypeptides. They function as probes similar to the nucleic acid probes for microarray assays. The use of nt and amino acid sequences as probes contrasts with the use of nt and amino acid sequences on chromosomes or polypeptides for biological functions. In vivo nt and amino acid sequences are for the most part involved in the synthesis of proteins and other molecular components. The digital CNSP and CAASP probes also differ from the nucleic acid probes of microarrays in that the digital probes can be matched in ways other than by the exact complementarity.

Many of the methods described by the present CNSP and CAASP methodology are novel, innovative, inventive, unconventional, and have never before. They amount to significantly more than is specified by the naturally ordered nucleic or amino acids on an individual's chromosomes or polypeptides for many reasons. The methods of the present application compute the RR, x2, and r2 measures of association with an examined disease or trait phenotype for each CNSP or CAASP of the given length. These statistical measures of association specify more than is specified by the natural sequence of nucleic acids on an individual's chromosomes since the correlations and other measures of association indicate the extent to which the occurrence of particular nucleic or amino acid sequences is implicated in the expression of an examined disease or trait phenotype. The natural sequence of nucleic acids on an individual's chromosomes alone does not indicate the extent to which particular sequences are implicated with the expression of a phenotype. This is indicated by comparing the occurrence of the sequence on a group of individuals expressing the phenotype with the occurrence of the sequence on a group of individuals that do not express the phenotype rather than solely by examining the sequence of nts on the chromosomes of a single individual as occurs in nature.

The computation of the statistical measures of association further involves far more than simply using a mathematical formula to derive statistics such as the relative risk, chi square, or correlation coefficient. In addition to setting up the experimental design contrasting case and control group individuals it involves, inter alia, detecting whether a particular nucleic acid sequence matching a probe occurs on the chromosomes of individuals. Thus, the correlations are not self-revealing based on an individual's natural nucleic acid sequence alone, but require the application of various experimental designs and analytic techniques of detecting and computing.

It is axiomatic that a disease or trait phenotype is a product of both nature and nurture. The expression of an individual's phenotype is a function of both genetic (i.e. nature) and environmental components, including the behavior of the individual (i.e. nurture), as opposed the phenotype being deterministically expressed solely as a result of nucleic or amino acid sequences on chromosomes or polypeptides without regard to an individual's actions. Although there are a few Mendelian diseases for which certain nucleic acid sequences ordinarily result in the expression of the disease, such as Huntington's disease, for vastly more diseases, including nearly all of the diseases that commonly affect individuals and lead to their deaths such as heart disease and cancer, the nucleic acid sequences are far less deterministically implicated in the expression of disease, but rather indicate the susceptibility to the expression of disease. The relationship between nucleic acid sequence presence and disease is, thus, overwhelmingly probabilistic rather than deterministic.

Because disease expression is a product of nature and nurture the correlation between nucleic acid sequences on an individual's chromosomes and a disease phenotype is likewise a function of nature and nurture. It is well known that a person's lifestyle can affect a person's susceptibility to disease. Identical twins, who have the same DNA and amino acid sequences since they are formed from a single fertilized egg, rarely have the same medical history. Studies of identical twins reveal that smoking habits, physical activity, and diet, among other factors, influence the correlations of sequence-specific DNA to methylation phenotype and epigenic modification, and that the magnitude of such differences between identical twins for such correlations increase as they grow older. “Epigenetic differences arise during the lifetime of monozygotic twins.” Fraga, M. F. et al. (2005) PNAS 102, no. 30, 10604-10609; Jaenisch, R. & Bird, A. (2003) Nat. Genet. 33, Suppl., 245-254; Bjornsson, H. T., Fallin, M. D. & Feinberg, A. P. (2004) Trends Genet. 20, 350-358. Individuals with particular nt sequence variants that react adversely to environmental damage, such as damage from sunlight for some melanomas, are more likely to express examined diseases than those without these variants but with similar environmental exposure, but individuals with greater exposure to environmental damage are further expected to express the examined disease. “Geographical Variation in the Penetrance of CDKN2A Mutations for Melanoma” (2002) Bishop D. T., et al. Journal of the National Cancer Institute, v94, No. 12, 894-903.

It is, accordingly, not accurate to state as a general rule that the correlation between the sequences of nucleic acids on an individual's chromosomes and a disease is a “relation {that} itself exists in principle apart from any human action” or that the “correlation is the handiwork of nature which man did nothing to bring about.” While the nucleic acid sequence of an individual is natural, the expression of a disease in an individual is a function of both nature and nurture.

The correlation between nucleic acid sequences and a disease phenotype differs from the “natural laws describing the relationships between the concentration in the blood of certain thiopurine metabolites and the likelihood that the drug dosage will be ineffective or induce harmful side-effects” based on “how the body metabolizes the drug” that were at issue in Mayo Collaborative Servs. v. Prometheus Labs., Inc., 132 S. Ct. 1289 (2012) (Mayo). Unlike the correlations involving purely chemical reactions at issue in Mayo, for which there is almost no human involvement, the correlations between nucleic acid sequences and a disease phenotype are most often based on both the nucleic acid sequence which is natural and environmental factors which are often to a significant degree the result of an individual's own actions.

The Mayo Court did not limit its holding to a finding that the claims at issue involved natural laws. It further addressed whether the patent claims add enough to their statements of natural laws to allow the methods they described to qualify as patent-eligible processes that apply natural laws. In Mayo the claimed methods involved well-understood, routine, and conventional activity previously engaged in by researchers in the field. In contrast to Mayo, many of the methods employed for the present application are not routine and not conventional, but instead are novel, innovative, inventive, unconventional, and have never been done before.

The present application describes the first method to detect and associate literally each nucleic acid sequence of a given length on chromosomes or genes of examined individuals. This vastly increases the coverage of nts that can be associated with the expression of disease from less than one percent of total nts on a chromosome or gene to literally one-hundred percent. The present application similarly describes the first method to detect and associate literally each amino acid sequence of a given length on amino acid sequences, such as polypeptides or proteins, of examined individuals.

Further, it describes the first method of reporting various statistics of association, such as the relative risk (RR), chi square (x2), and correlation coefficient (r2), together with their CNSPs of the given length in the normal 5′-3′ direction for the entire length of chromosomes or genes of examined individuals, as well as the first method of reporting these statistics together with each CAASP in the normal C-to-N terminus direction for the entire length of the polypeptides of examined individuals. This for the first time focuses on the exact order and location of nt and amino acid variants most highly implicated in the expression of the phenotype continuously and without interruption from the beginning to the end of chromosomes and polypeptides of examined individuals.

The present application is the first to match probes consisting of each of the contiguous nucleic or amino acid sequence polymorphisms in lengths from 2 to 99, i.e. CNSPs and CAASPs, from the sequence data of chromosomes or polypeptides of the aggregate of case and control group individuals, with the sequence data for these individuals separately in obtaining the number of case and control group individuals on whose sequence data the probe sequences occur for the purpose of deriving association statistics, as opposed to the prevailing SNP GWAS method that compares SNP probes derived from small reference groups with the sequences of both case and control group individuals. The CNSP and CAASP method, thus, can for the first time identify genetic variation that is endemic to particular geographic or ethnic groups by selecting examined individuals from a particular geographic area or a particular ethnic group for a CNSP or CAASP study. Such endemic variation cannot be discerned when comparing case and control group individuals to a general reference database, such as the HapMap database which is derived from only several hundred people and applied to all populations world-wide, in obtaining the number of case and control group matches for association statistics.

The CNSP methodology further involves the first identification of each polymorphism for association in the 5′-3′ order along the length of a single chromosome of a single individual, rather than defining polymorphisms based on the alignment of homologous chromosomes with one another so as to pick out allelic differences at a single locus on homologous chromosomes as for the SNP microarray methodology. Thus, unlike the SNP GWAS method, the CNSP and CAASP method does not need an a priori established reference database of probes for comparison with the sequences of case and control group individuals as a prerequisite to an association study. The CNSP and CAASP method is also the first to associate polymorphisms of case and control group individuals without having to align homologous chromosomes to establish probes, which greatly facilitates the ability to conduct association studies given the necessarily laborious efforts needed to generate SNPs at a reasonable degree of accuracy when multiple homologous chromosomes are aligned.

A commonly accepted view today is that it is only necessary to examine the common variation between the homologous chromosomes of individuals, the most predominant form of which is the SNP, in order to understand the genetic variation related to disease expression, such as expressed by the following quote by Feuk: “A striking observation from the analysis of the human genome is the extent of DNA-sequence similarity among individuals from around the world. Any two humans are thought to be about 99.9% identical in their DNA sequence. It is therefore through studies of a small fraction of the genome which constitutes the genetic variation between individuals that insights into phenotypic variation and disease susceptibility can be gained.” Feuk, L., et al. “Structural variation in the human genome.” Nature Reviews Genetics 7, 85-97 (2006). This quotation provides the rationale for the SNP methodology, which focuses on the common variation for about one of every one-thousand nts on a chromosome.

But the sequence differences between individuals in the population do not occur at the same location on the homologous chromosomes of all people. While sequence differences between any two individuals in the human population are individually rare, they are collectively common between individuals and the population as a whole. Some member of the population differs from another member of the population for about 99.9% of the billions of loci on the human genome. Altshuler, Daly, and Lander state in this regard “Most Mendelian diseases involve rare mutations that are essentially never observed in the general population. Rare mutations likely also play an important role in common diseases. Because they are numerous and individually rare, it is not possible to create a complete catalog in the general population. Instead, they must be identified by sequencing in cases and controls in each study . . . the universe of rare structural changes contributing to each disease may be as large and diverse as that of common SNPs. “Genetic Mapping in Human Disease.” Altshuler, D., Daly, M., and Lander, E. Science. (2008). The SNP GWAS method does not detect rare variants. However, the present CNSP and CAASP method detects all variants, common and rare. The present CNSP and CAASP method is the first to detect all rare variants in a study.

The prior art for discerning the impact of nucleic acid sequences upon the etiology of common diseases is inextricably tethered to SNP GWAS methods to discern DNA variants implicated with the expression of disease. SNP GWAS have been successful in identifying common SNPs statistically associated with complex diseases but these associations appear to confer modest risk and few causal alleles have been identified. The Director of the National Institute of Health's (NIH's) National Human Genome Research Institute (NHGRI) has recently stated in this regard that “Given how little has actually been explained of the demonstrable genetic influences on most common diseases” it “is becoming clear from these early attempts at genetically based risk assessment that currently known variants explain too little about the risk of disease occurrence to be of clinically useful predictive value.” “Genomewide Association Studies and Assessment of the Risk of Disease” Manolio, T. N Engl J Med (2010) 363:166-76. One of the primary reasons that the SNP GWAS methods do not reveal causal variants of diseases is that the methods do not comprehensively associate nucleic or amino acid sequences with disease, but instead associate only a minuscule portion, comprising less than one percent of the nts on a chromosome, of the genetic variation with disease, and those portions that are implicated are only markers that suggest an area in linkage disequilibrium tens of thousands of nucleotides in length in which the causal variants responsible for the expression of the phenotype likely reside.

In contrast to SNP GWAS the present application associates literally every nucleic and amino acid sequence of a given length with the examined phenotype. This is novel in the direct sense that it had never been done before. Nor have previous methods come close. Neither SNP GWAS nor any other method has associated as many as one percent of the total nts on chromosomes or genes with examined phenotypes. Common SNPs only occur about once for every one thousand nucleotides, or for about one-tenth of one percent of the total nucleotides on a chromosome or gene. “Genetic Mapping in Human Disease” Altshuler, D., Daly, M., and Lander, E. Science. (2008). Thus, if literally every common SNP were examined by microarrays only one-tenth of one percent of the total nucleotides on a chromosome or gene would be associated.

SNPs account for about 90% of the DNA sequence polymorphisms between the homologous chromosomes of humans that are presently capable of being associated with disease or traits. “The 1,000 Genome Project: An integrated map of genetic variation from 1,092 human genomes.” Nature (2012) 491:56-65. While SNPs comprise the most abundant type of variant and are the best-studied, it is increasingly clear that structural variants comprising sequence alterations (e.g. insertions and deletions), copy number variants (e.g. duplications), inversions, translocations, and other sequence rearrangements are integral features of the human and other genomes, although it has been concluded that the magnitude of this variation is too small to fill the void of missing heritability left by SNP GWAS. “Origins and functional impact of copy number variation in the human genome.” Conrad D. F, et al. (2010) Nature 464:704-712. “Genetic association analysis of copy number variation (CNVS) in human disease pathogenesis.” Iuliana Ionita-Laza et al. Genomics. 2009 January; 93(1): 22-26. doi:10.1016/j.ygeno.2008.08.012. Methods for the analysis of structural variations are further not nearly as well developed as for SNPs. Beckmann, J. S., et al. “Copy number variants and genetic traits: Closer to the resolution of phenotypic to genotypic variability.” Nature Reviews Genetics 8, 639-646. Whereas SNPs involve only a single nt on a chromosome, structure variants, especially copy number variants, involve many more nts with copy number variant lengths ranging in size from 443 nts to 1.28 million bases with a median of 2,900 bases. “Origins and functional impact of copy number variation in the human genome.” Conrad D. F, et al. (2010) Nature 464:704-712. Recent estimates place the total genetic variation between individuals resulting from structural variants at 0.2 percent of the genome, i.e. about two-tenths of one percent of the genome, whereas the total genetic variation between individuals resulting from common SNPs is 0.1 percent, i.e. one-tenth of one percent of the genome. Schrider D. R. and Hahn M., Proc. R Soc B (2010) 277, 3213-3211. Thus, the number of SNP and structural variant nts together total about one percent or less of the total nts on genes or chromosomes when all specifically identified variants, both SNPs and structural variants, are combined. Although the existing microarray methods do not come close to examining all such variants, even if they did they would only cover about one percent of total nts on chromosomes at most. This is far short of the one-hundred percent coverage of literally every variant of a particular length by the present CNSP and CAASP application.

Other than lack of coverage, another reason for the inability of present methods to locate causal variants is that the regions implicated by SNP GWAS, which typically range between 10,000 to 100,000 nt bases, are too large to systematically explore the underlying metabolic, biological, and other bases for expression. “Genetic Mapping in Human Disease.” Altshuler, D., Daly, M., and Lander, E. Science. (2008). According to the NHGRI director narrowing an implicated region to variants that directly cause susceptibility to disease by disrupting the expression or function of a gene or displaying some other functional effect has proven elusive to date, but this will be a key step in improving our understanding of the mechanisms of disease and in designing effective strategies for risk assessment and treatment. “Genomewide Association Studies and Assessment of the Risk of Disease” Manolio, T. N Engl J Med (2010) 363:166-76.

It is believed that the CNSP method will be instrumental in this regard not only because of its vastly greater coverage in terms of the number of nts on chromosomes that can be associated by the CNSP and CAASP method as compared with the SNP GWAS method, but because of the ability of the CNSP and CAASP method to continuously order various measures of association in the 5′-3′ direction that CNS polymorphisms occur on DNA sequences or the C-to-N terminus direction that amino acid polymorphisms occur on polypeptides. This identifies the location of variants most highly associated with the examined phenotype at a vastly greater degree of refinement than ever before possible. Once the location of the variants implicated with the expression of the phenotype are identified efforts can be initiated to discern the underlying mechanisms that occur in conjunction with these variants, including the development of diagnostic tests, drugs, and other therapies to treat the phenotype.

Also the aggregation of each of the CNSPs or CAASPs of the given length together as a whole enables the evaluation of epistatic relationships of each CNSP with each other CNSP, and each CAASP with one another, of CNSPs with CAASPs, and CNSPs and CAASPs with environmental factors. The ability to evaluate inter-relationships between all segments of chromosomes or polypeptides is qualitatively as well as quantitatively different from the present ability to evaluate the relationships of individual SNPs which occur only once for every one thousand nts.

The accompanying FIGS. 1 to 13 at pages 86 to 100, which are incorporated into the specification, describe discrete steps involved in conducting the CNSP and CAASP methods. FIG. 1 through FIG. 4 relate respectively to one of the four working examples, as follows:
FIG. 1 (page 86)—Processes In Programming Line Number Order. Homo Sapiens—Nucleic Acid Associations
FIG. 2 (page 87)—Processes In Programming Line Number Order. Aquifex Aeolicus—Amino Acid Associations
FIG. 3 (pages 88-89)—Processes In Programming Line Number Order. Aquifex Aeolicus—Nucleic Acid Associations
FIG. 4 (page 90)—Processes In Programming Line Number Order. Aquifex Aeolicus—Amino Acid Associations

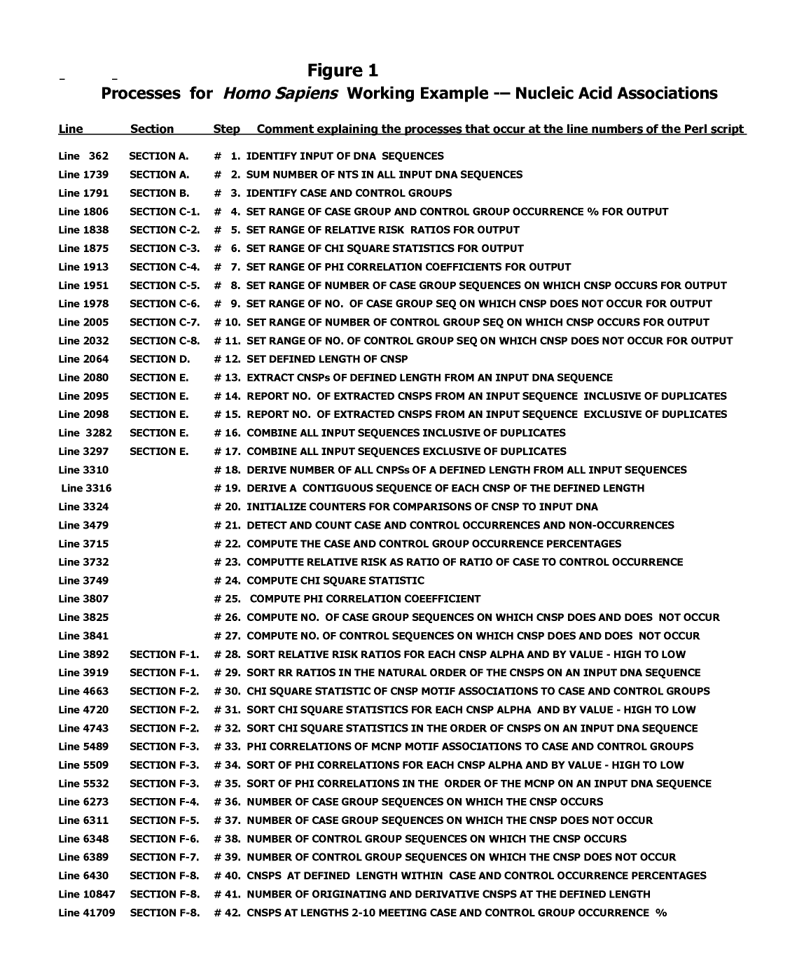

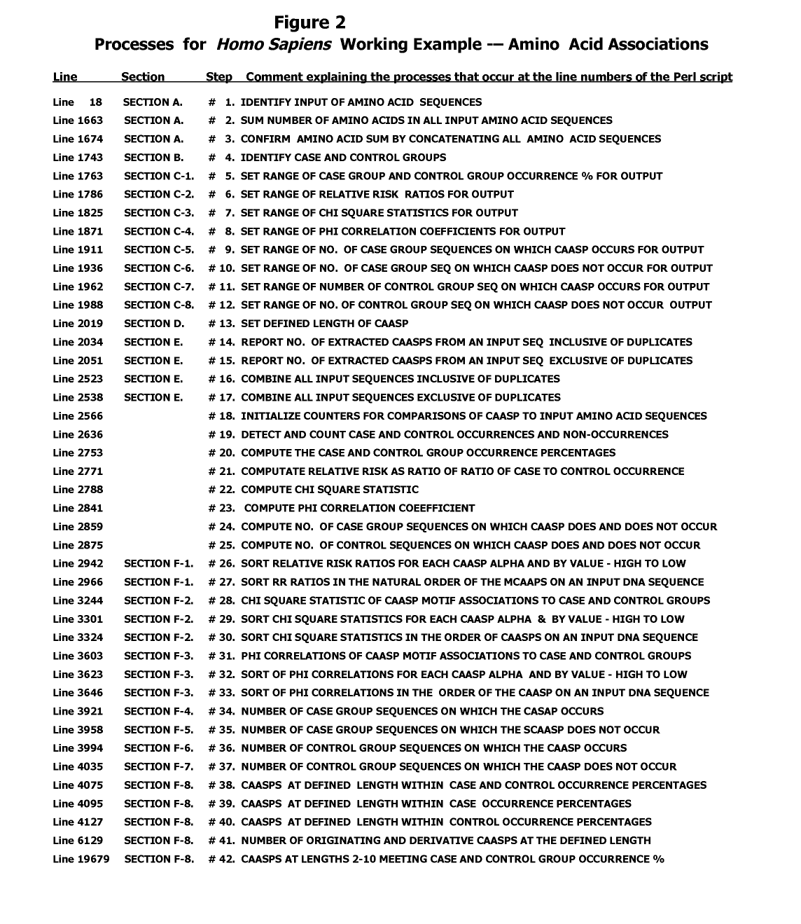

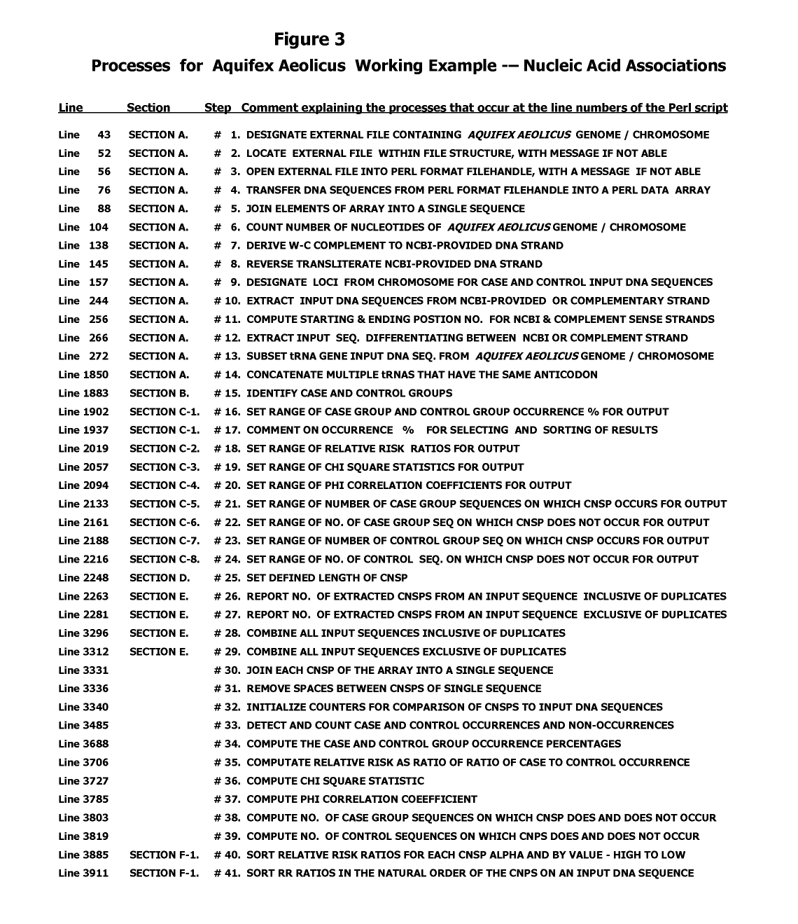

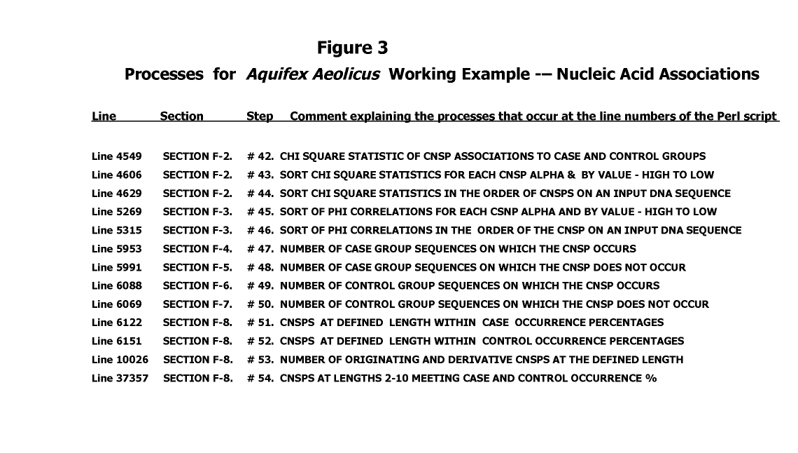

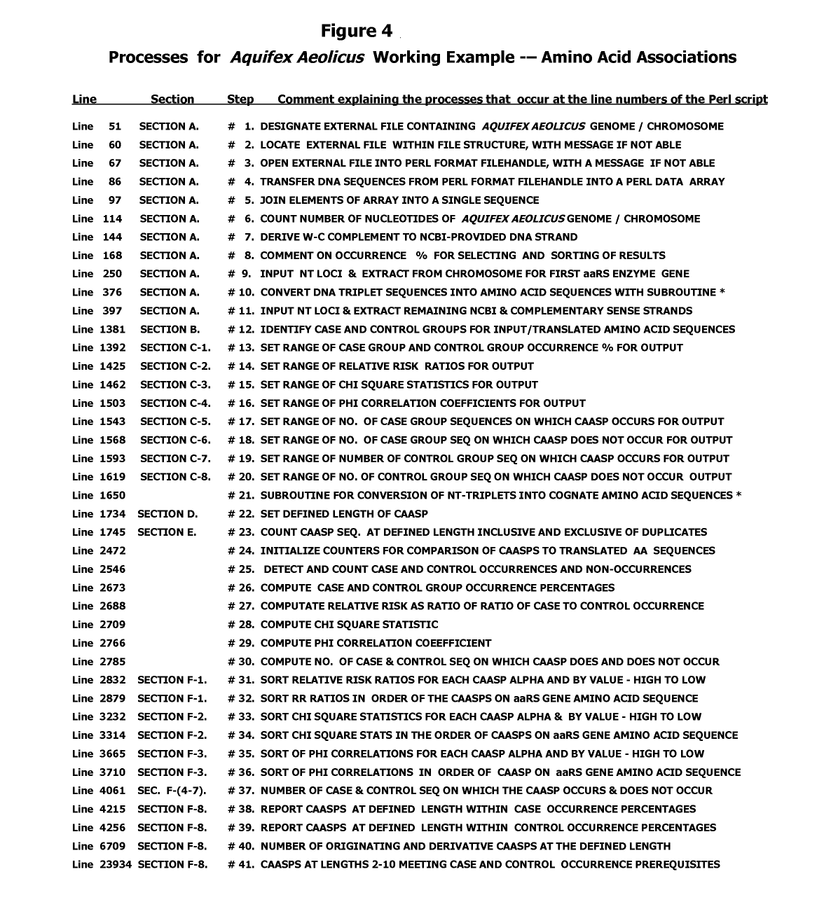

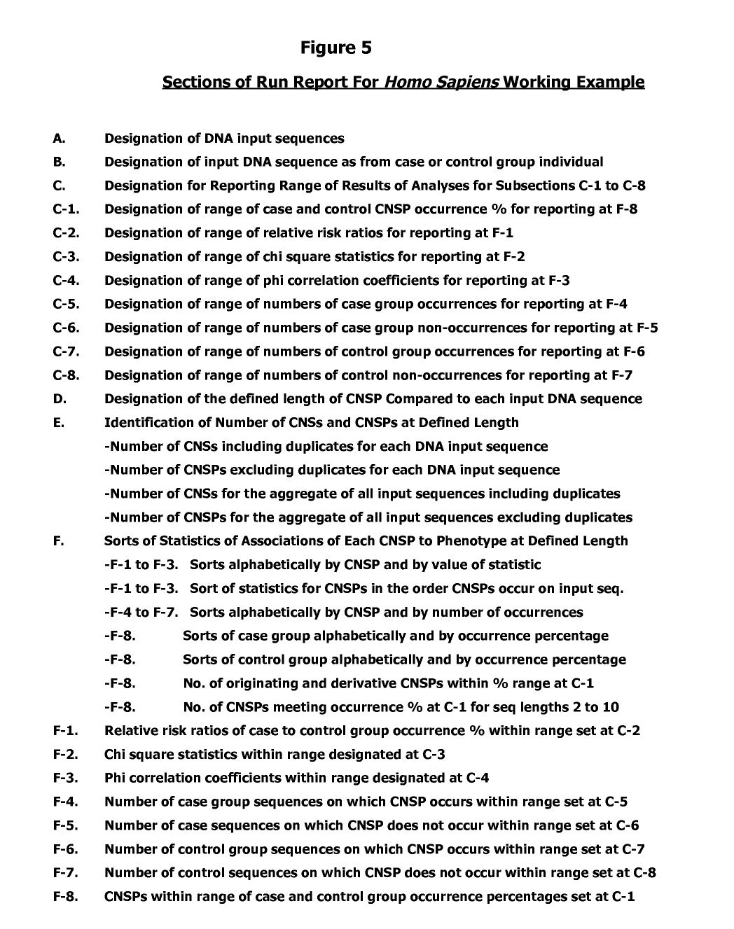

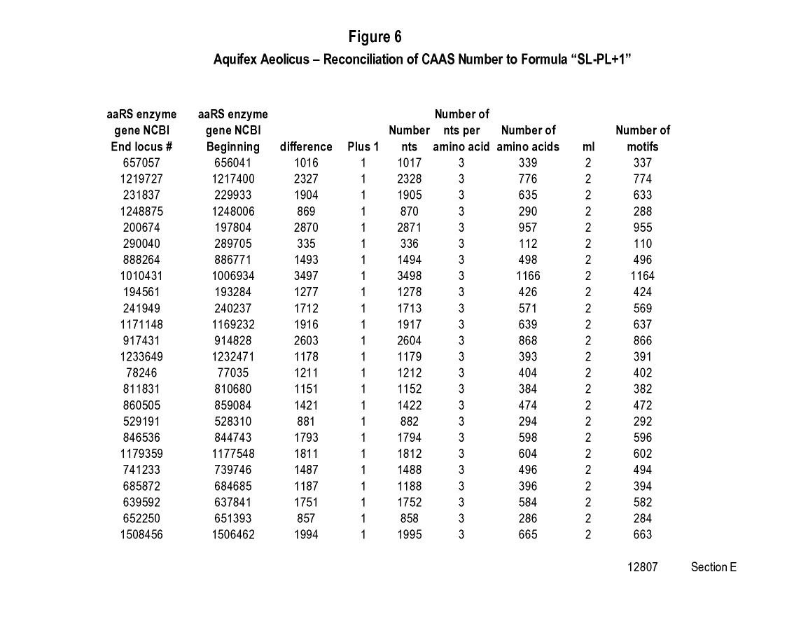

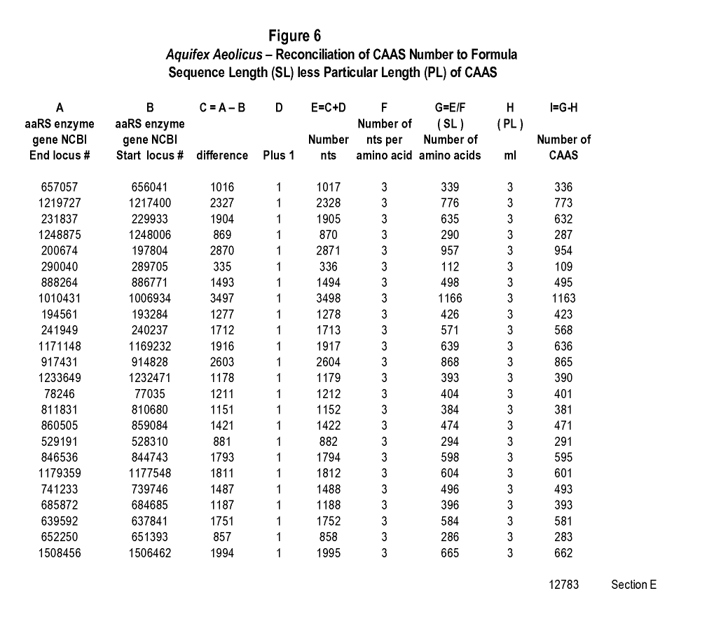

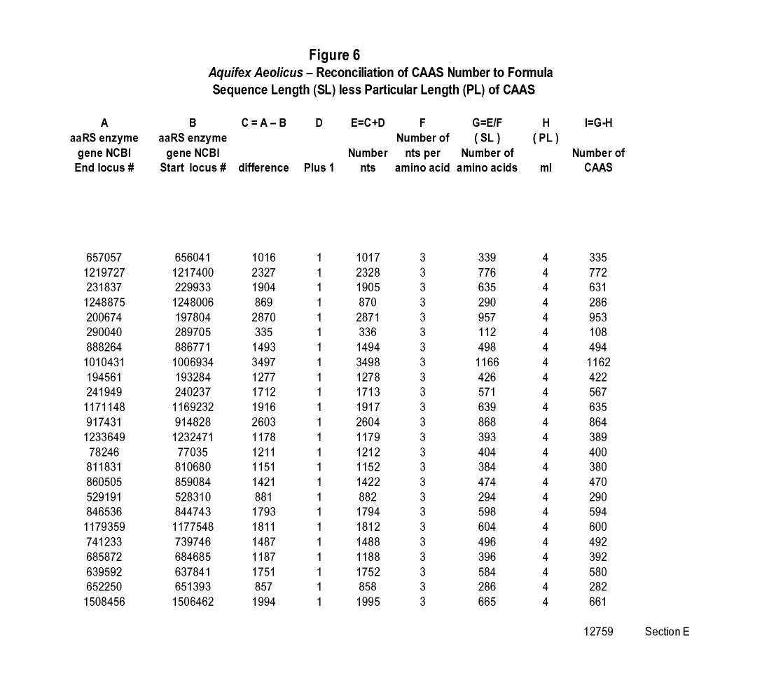

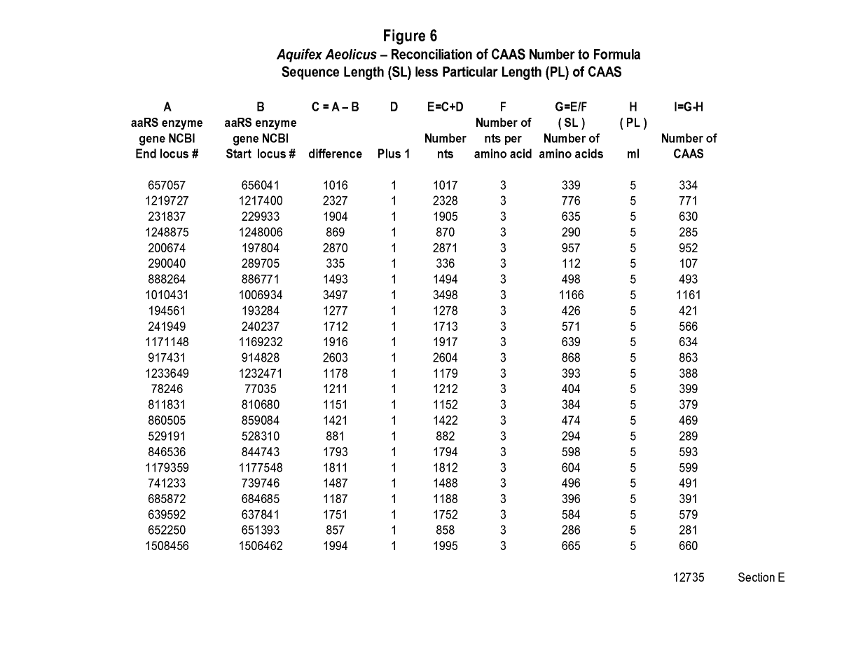

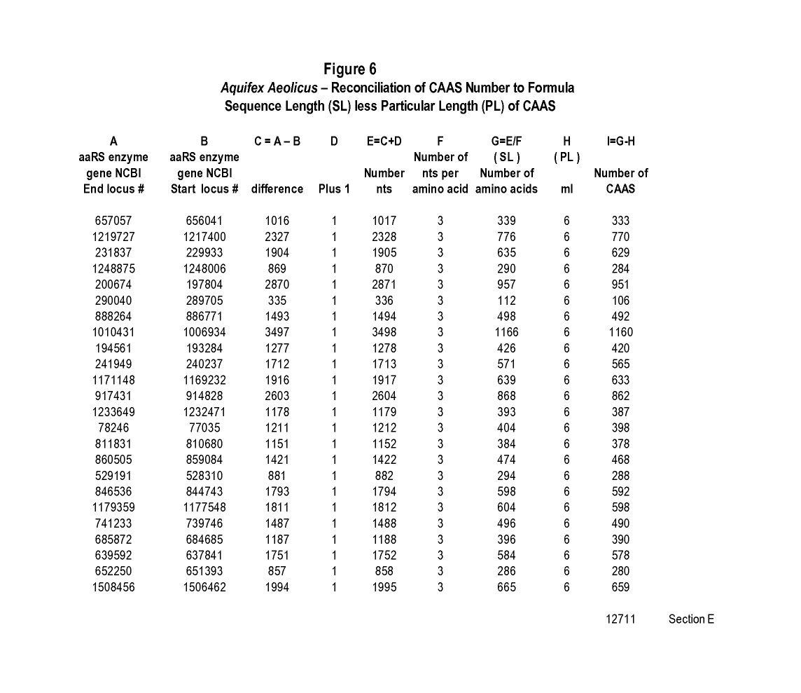

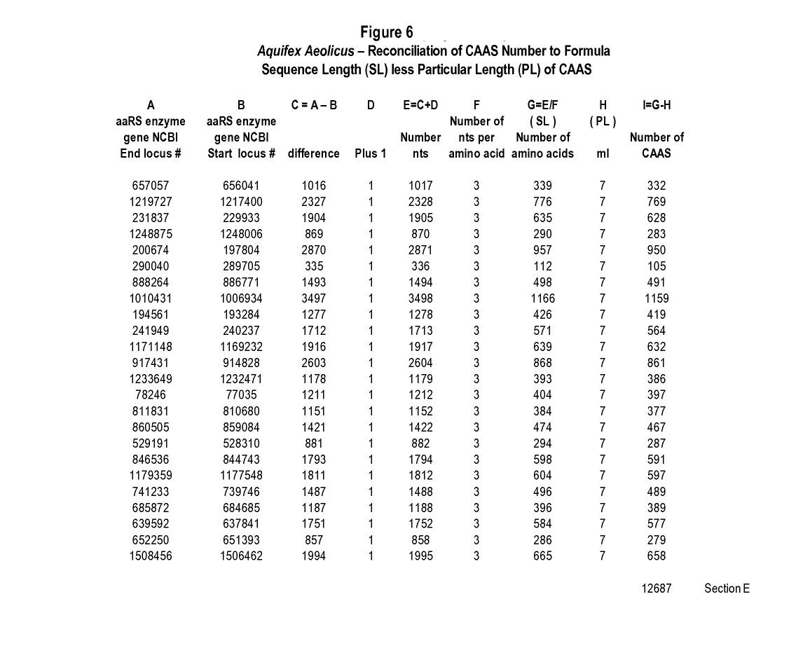

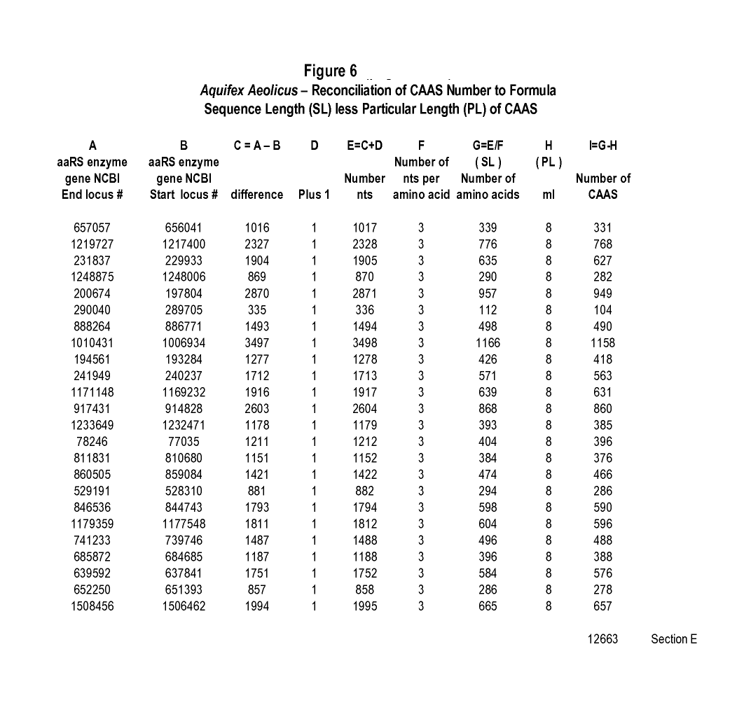

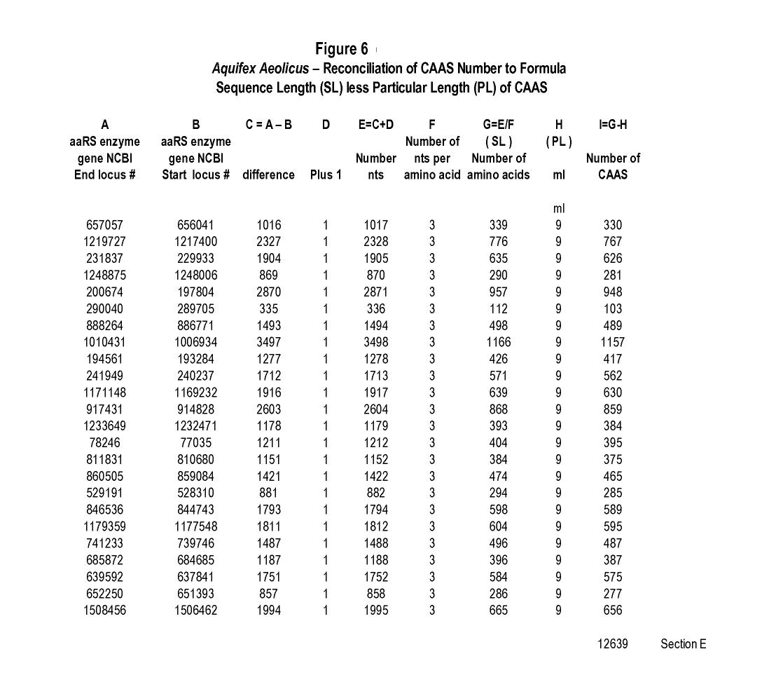

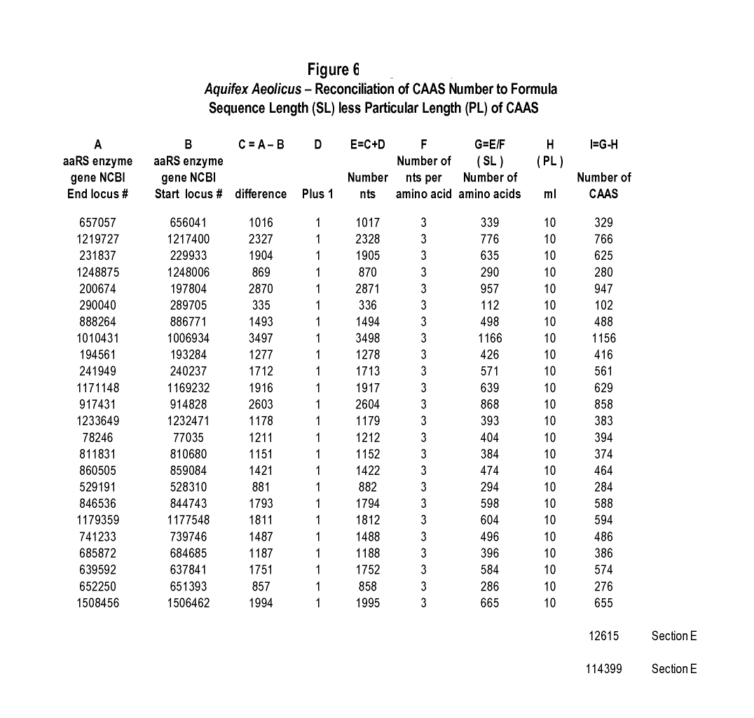

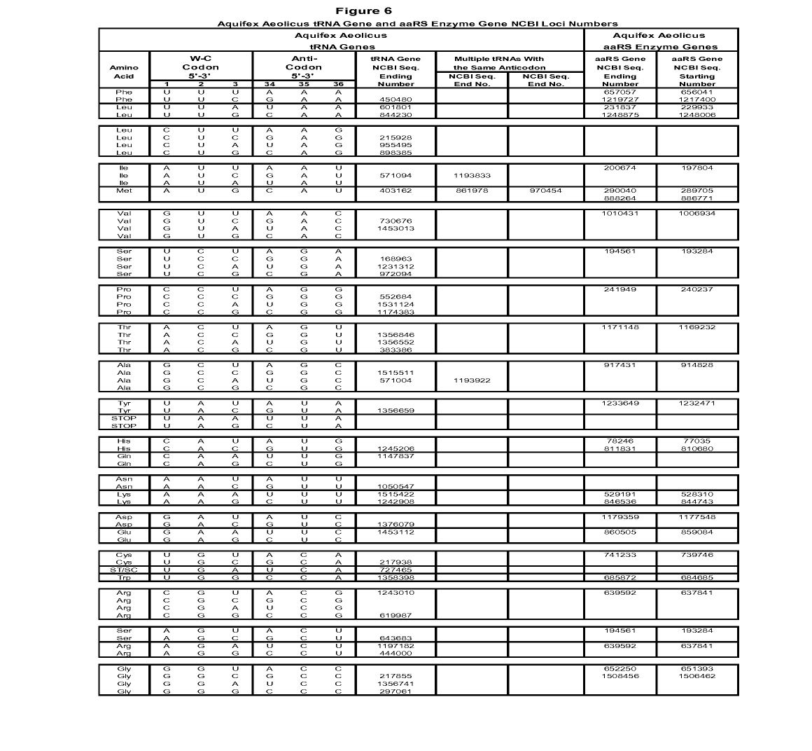

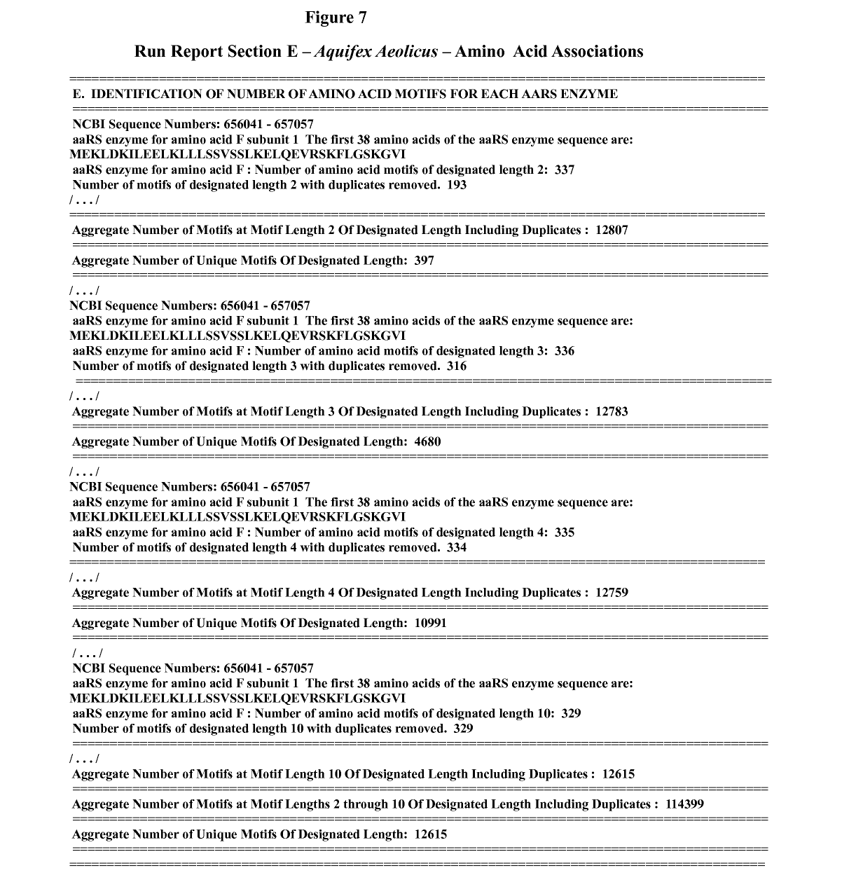

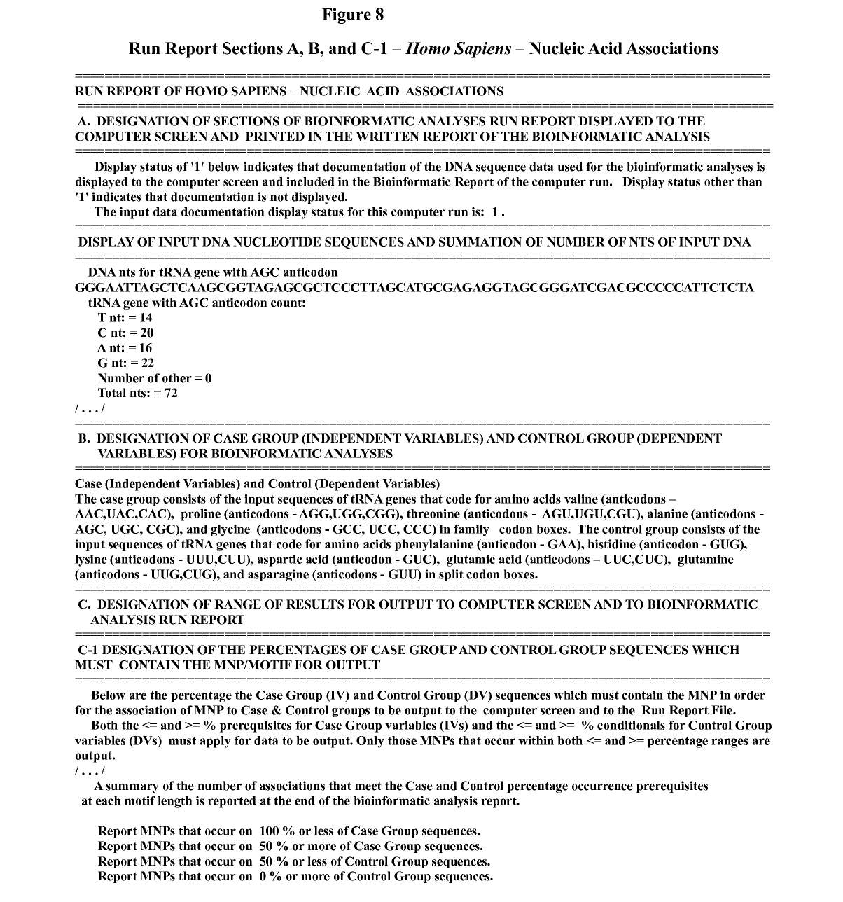

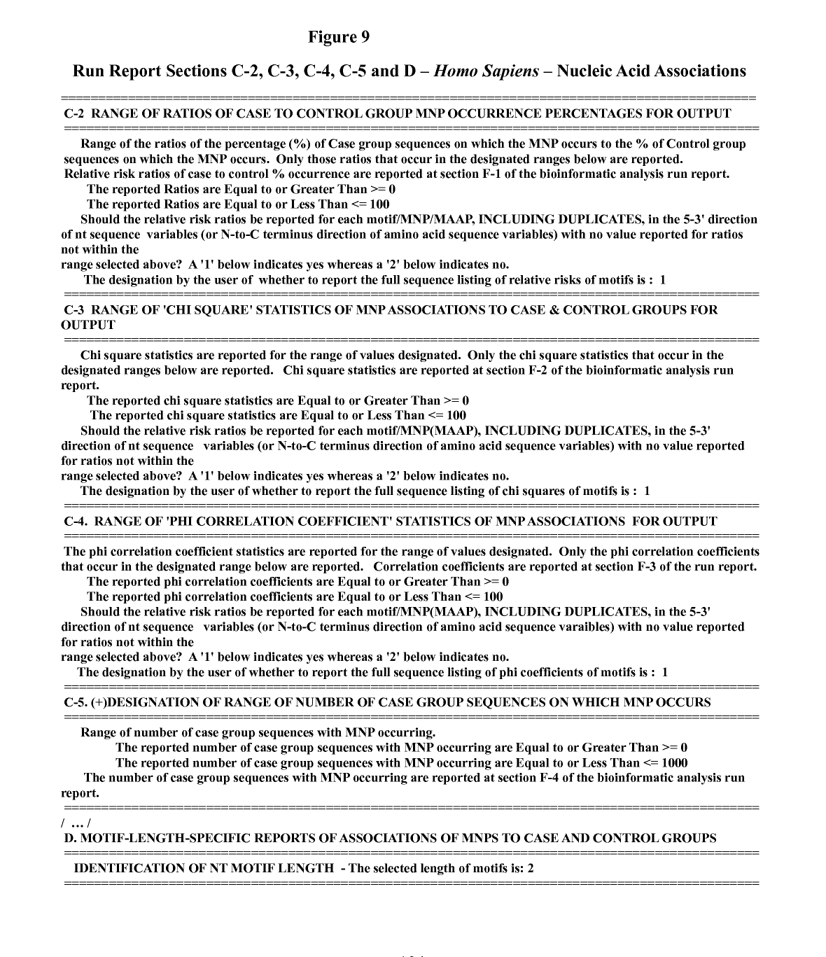

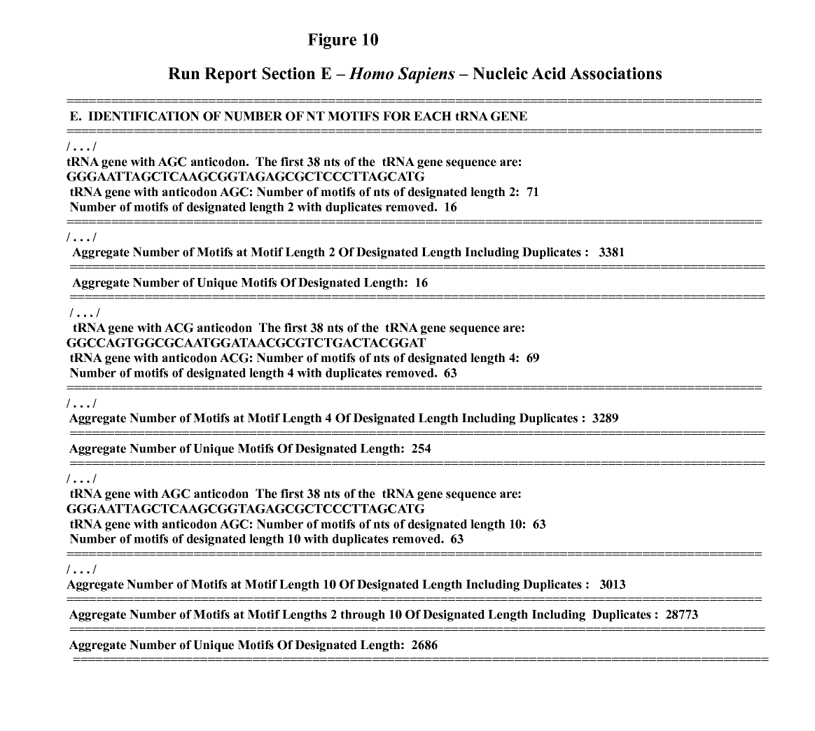

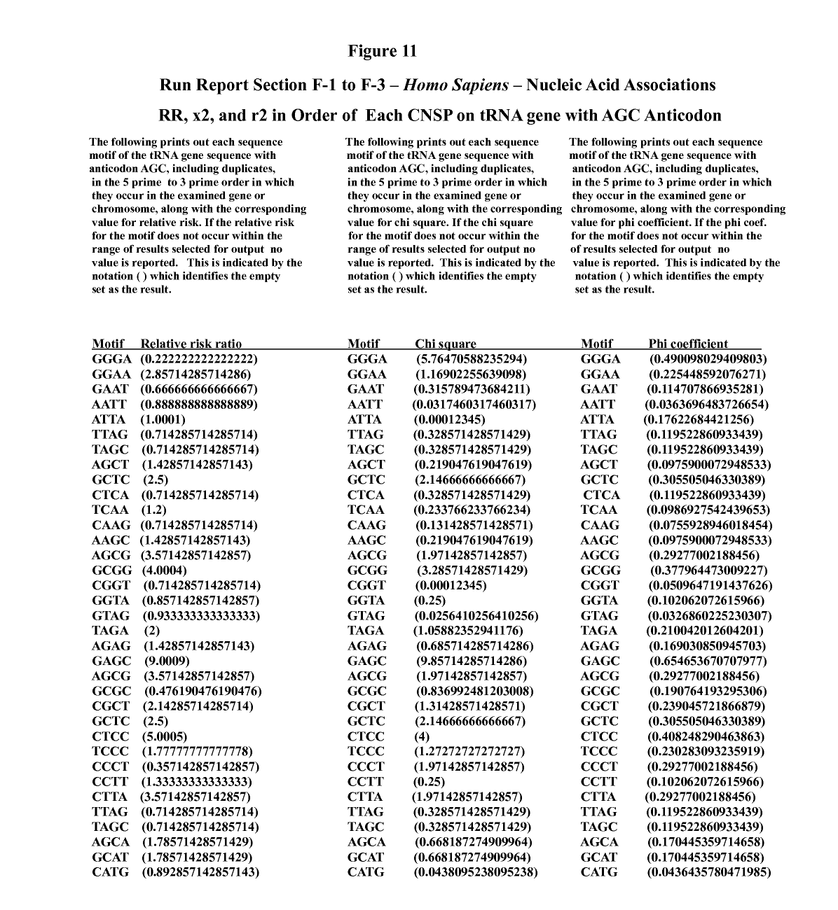

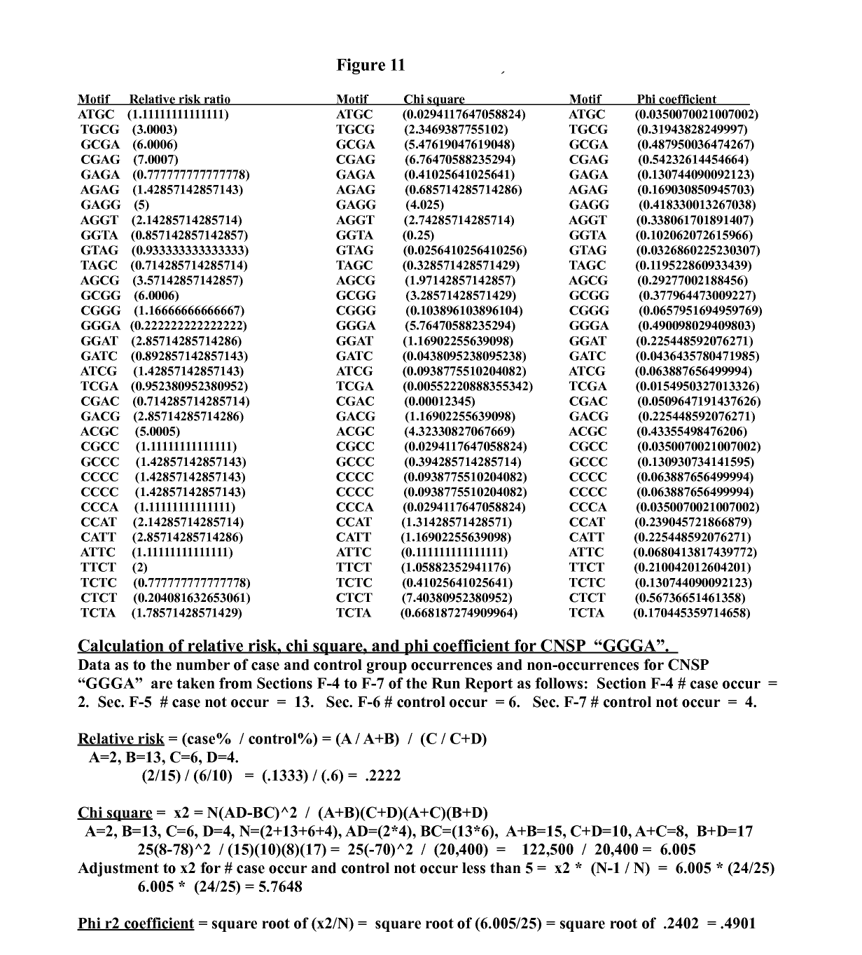

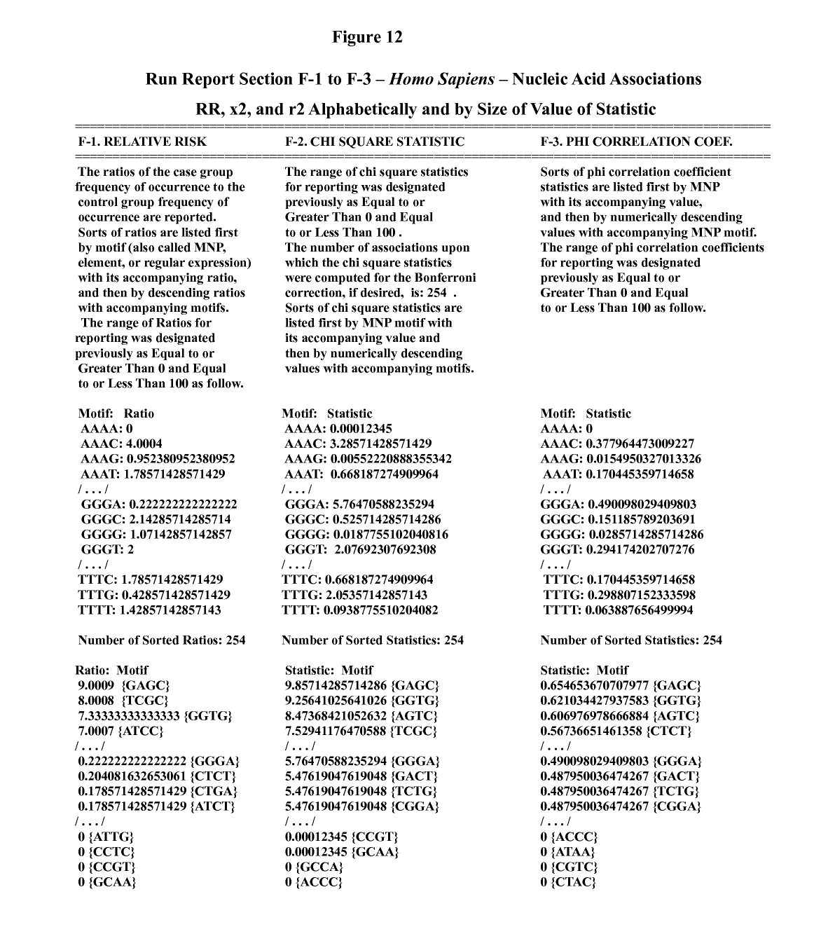

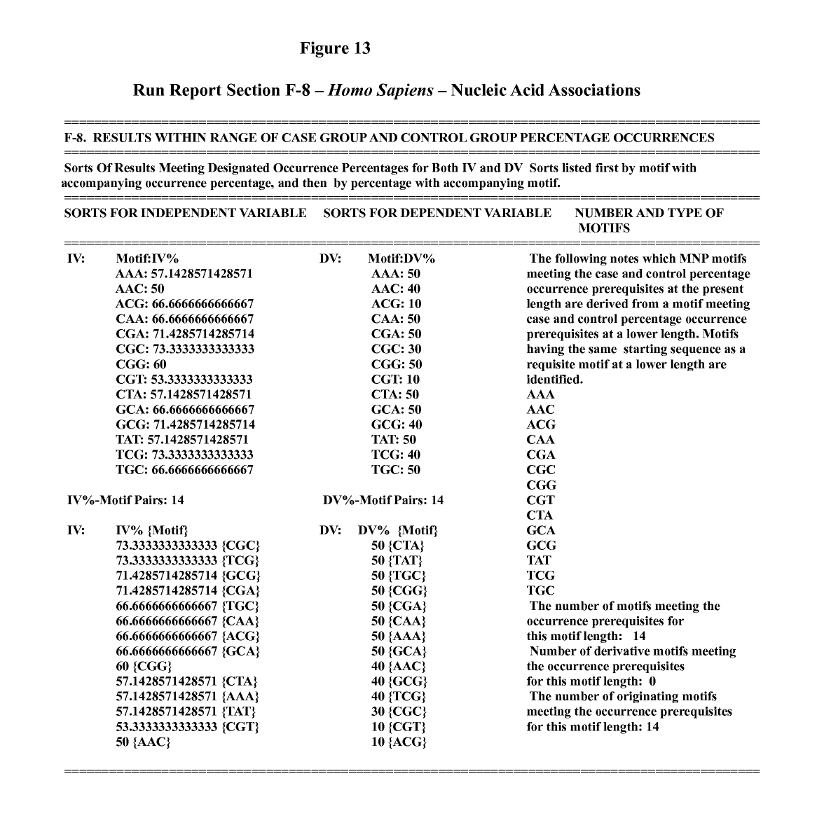

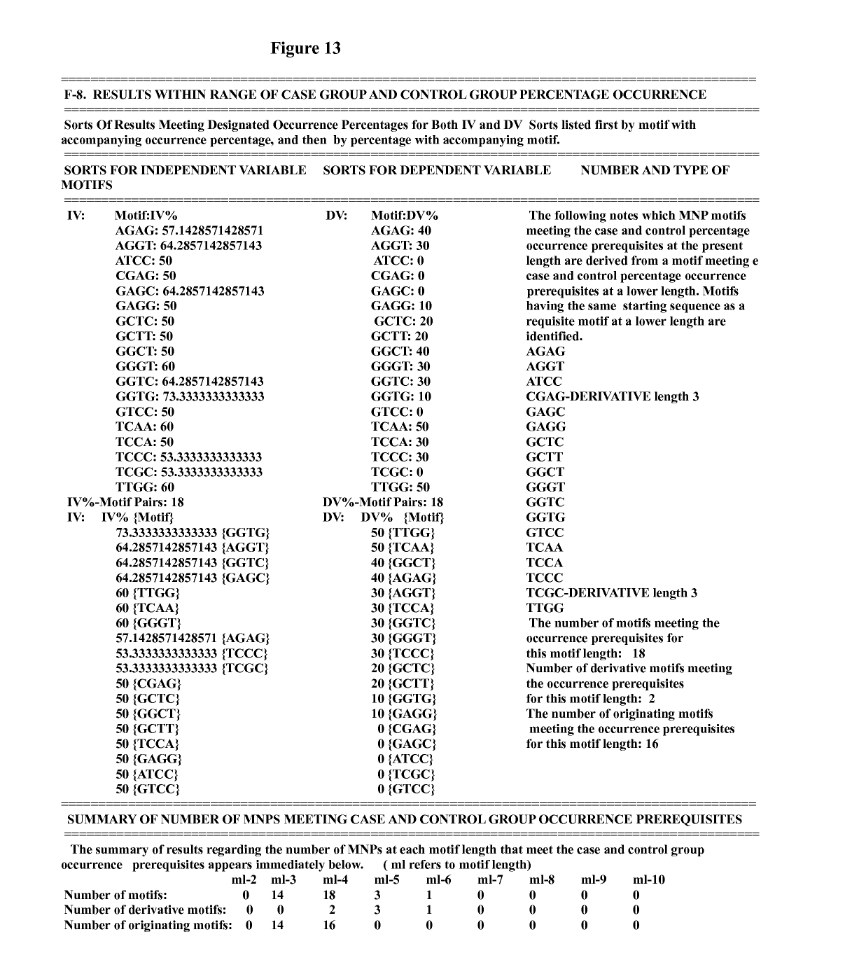

FIGS. 1 through 4 specify discrete steps employed for the four working examples, specifically indicating the program instruction line numbers for the steps, the sections of the run report for the discrete steps, the step numbers, and brief comments about the processes effected at particular line numbers of the Perl script for a step. Each time that the methodology is run the results of that particular run are documented by a computer-generated text file, referred to as the run report, and by the simultaneous display of the information in the report to the computer screen. The major sections of the run report are provided at FIG. 5, (page 91), captioned “Sections of Run Report.” The sections for FIG. 5 relate most particularly to the homo sapiens CNSP working example which is described in further detail by FIG. 1, but similar sections also apply to the other working examples described at FIGS. 2, 3, and 4. FIG. 6 consists of spreadsheets that demonstrate that literally every CAASP of the particular lengths two through ten for the aquifex aeolicus whole-genome amino acid analysis working example are examined by the present application by reconciling the number of CAASs calculated by the present application at Section E with the computational formula for the number of sequences of a particular sequence length including duplicates (e.g. CAASs) using the NCBI beginning and ending loci numbers, whereas FIG. 7 shows reported data for the corresponding working example related to FIG. 6.

The computer programs contain comment sections that explain how aspects of the Perl programming language function, but these comments are themselves not processed. Certain terminology in the comments for the working examples and in the output of the run reports themselves differs from that mentioned in the present narrative. For example, the term “case group” is often referred to as the “independent variable or IV” and “control group” is referred to as the “dependent variable or DV.” Also the term “contiguous nucleotide sequence polymorphism” or CNSP is often referred to a “multiple nucleotide polymorphism” or “MNP” and the term “contiguous amino acid sequence polymorphism” or CAASP is often referred to a “multiple amino acid polymorphism” or “MAAP.” Also the term “motif” is often used to refer to a CNS, a CNPS, a CAAS, or a CAASP.

Sections A through D of the run reports specify data input by the computer user. For the homo sapiens working examples the sequence data is manually input into the programming lines by the user. This data consists of the sequence of nucleic acids for one of each of the 46 homo sapiens tRNA genes with a different anticodon, and of the sequence of amino acids for one of each of 18 different aaRS enzyme genes. For the aquifex aeolicus working examples the input data consists of the sequence of nts of the single chromosome of the bacterium, which programming instructions read into a Perl scalar variable from an external file. For the working examples the sequence data of certain tRNA genes are identified as case group members whereas sequence data of other tRNA genes are identified as control group members, or the sequence data of certain aaRS genes are identified as case group members whereas the sequence data of other aaRS genes are identified as control group members. This would differ from studies involving diseases or traits of individuals where the nt or amino acid sequences of certain individuals that express an examined phenotype would be identified for the case group while sequences of other individuals that do not express the phenotype would be identified for the control group.

Prokaryotes such as the bacterium aquifex aeolicus do not have introns within the nucleic acid sequence data of chromosomes, whereas eukaryotes such as humans do have introns. For eukaryotes, introns also appear in the nucleic acid sequences of non-protein coding genes such as tRNA genes but are post-transcriptionally removed. In vivo, introns are not expressed in the translated amino acid sequences on polypeptides since the introns are spliced out post-transcriptionally but before translation.

For the working example of the prokaryote the full nucleic acid sequence of the genome was input and the tRNA gene nucleic acid sequence data of interest was extracted. Also, for the prokaryote the aaRS enzyme amino acid sequence data of interest was derived by first extracting the sequence of aaRS enzyme gene nucleic acids and then the nucleic acid sequence was bioinformatically translated into a corresponding sequence of single-letter amino acids using a computer subroutine that returned cognate amino acids for nt-triplet codons corresponding to the assignments of codons to amino acids of the canonical genetic code.

The DNA nts for both the tRNA genes and the aaRS enzyme genes of the prokaryote were obtained by internet download of the sequence of all of the DNA nt bases on one of the two strands of the DNA double helix of the single chromosome of aquifex aeolicus from the website of the U.S. National Center for Biotechnology Information (NCBI) from the file fasta.htm and pasted into a Microsoft notepad file, namely FASTA.txt” which was used for input into the working example. The NCBI annotation for the aquifex aeolicus genome has the following filename: viewer.fcgi.htm.

But for the eukaryote homo sapiens, which does have introns, in order for the present application to conduct the nucleic or amino acid analyses the input sequence data must have already had the introns removed since the present application's methods cannot discern where the introns start and where they end. Thus, for the working examples involving homo sapiens segments of interest from the homo sapiens genome from which the introns had already been removed were directly input into the programming instructions of the homo sapiens working examples. These input segments consisted of certain tRNA gene nucleic acid sequence data and certain aaRS enzyme gene amino acid sequence data.

The DNA nts of homo sapiens tRNA genes were obtained by download from the University of California Santa Cruz (UCSC) genomic tRNA database for the tRNAScan-SE of homo sapiens (hg19-NCBI Build 37.1 Feb. 2009) from the file “hs19-tRNAs.fa” (97 Kb) which was pasted into a Microsoft notepad file hs19-tRNAs.fa.txt” (97 Kb) which was used for the working example by copying the tRNA gene sequence data of interest from this file and pasting it directly into the Perl program instruction lines for the working example. These data sources do not conform to the filing requirements for sequence listings, but they document the sequence data used in the working examples and are, accordingly, provided as part of the information disclosure statement pertaining to the present application.

The sequences of amino acids on homo sapiens aaRS enzymes were downloaded from the NCBI reference sequence database and pasted into the following Microsoft notepad files, with byte sizes of between 15 and 30 Kb. The filenames and NCBI reference sequences IDs are as follows: alanyl.txt (REFSeq ID: NM 001605), arginyl.txt (REFSeq ID: NM 00288), asparaginyl.txt (REFSeq ID: NM 002745), aspartyl.txt (REFSeq ID: NM 001349), cystyl.txt (REFSeq ID: NM 00175), glutyaminylgln.txt (REFSeq ID: NM 005051), glycyl.txt (REFSeq ID: NM 002047), histidyl.txt (REFSeq ID: NM 002109), isoleucyl.txt (REFSeq ID: NM 002161), leucyl.txt (REFSeq ID: NM 002117), lysyl.txt (REFSeq ID: NM 005548), methionyl.txt (REFSeq ID: NM 004990), phenylalanyl.txt (REFSeq ID: NM 004461), phenylbeta (REFSeq ID: NM 005687), seryl.txt (REFSeq ID: NM 006513), threonyl.txt (REFSeq ID: NM 152295), tryptophanyl.txt (REFSeq ID: NM 004184), tyrosyl.txt (REFSeq ID: NM 003680), and valyl.txt (REFSeq ID: NM 006295). These data sources do not conform to the filing requirements for sequence listings, but they document the sequence data used in the working examples and are, accordingly, provided as part of the information disclosure statement pertaining to the present application. The homo sapiens amino acid sequence data was copied from the above files and directly pasted into the Perl programming instructions for the homo sapiens amino acid analysis working example.

Sections A, B, and C appear in the run report for the working examples only once at the beginning of the report. Section A identifies the input sequence data by displaying the initial portion of each case or control sequence to the monitor and run report, and by displaying a count of the number of nts or amino acids for each input sequence. Section B identifies which input sequences the user indicates are from case group members and which are from control group members. The subsections of Section C specify the ranges of values for several measures of association for reporting to the run report. (See FIGS. 8 and 9 at pages 103 and 104).

The computer programs for each of the four working examples are separately appended and provided on CD-ROM. The computer programs have a .pl suffix. The run reports for the programs have the same prefix as the computer programs but a .txt suffix. The run reports do not conform to the filing requirements for computer programs, but they document the working examples and are, accordingly, provided as part of the information disclosure statement pertaining to the present application. The run report filenames for the working examples are: Aquifex aeolicus, nucleic acid analysis run report AQnt.txt (7,267 Kb); Aquifex aeolicus, amino acid analysis run report AQaa.txt (28,767 Kb); Homo sapiens, nucleic acid analysis run report HSnt.txt (8,556 Kb); Homo sapiens, amino acid analysis run report filename HSaa.txt (41,249 Kb).

A copy of the Windows version of the Perl programming language software, with filename ActivePerl-5.8.7.815-MSWin32-x86-211909.msi was installed on the computer on which the working examples were prepared to enable the communication of instructions from the Perl computer programs to the computer's operating system. The Perl Express IDE (Integrated Development Environment) v6.0.1.2 software, with filename PESetup25-1.exe was also used in conjunction with the Perl programming language software to facilitate the preparation of the Perl programs for the working examples.

Sections D, E, and F appear in the run report nine times, once for each of the nine particular CNSP or CAASP lengths, two through and including ten, examined by the working examples, except that the subsection F-8 sort that differentiates between originating and derivative base sequences for CNSPs or CAASPs for the user-selected range of case and control group occurrence percentages at C-1 does not appear for the initially defined length (i.e. two), but appears for each defined length thereafter and, accordingly, occurs eight times once for defined lengths three through ten. Section D identifies the particular length for the CNSPs or CAASPs. (See FIG. 8 at page 103).

Section E of the run report provides detailed information regarding the sequence data that is matched to the CNSPs or CAASPs in determining the association statistics. Section E first identifies each chromosome/gene or polypeptide that is matched to the CNSPs or CAASPs and displays the first 38 nts or amino acids of the sequence data for each such chromosome/gene or polypeptide. Then, Section E identifies both the number of contiguous nucleic or amino acid sequences of the particular given length, i.e. the CNSs or CAASs, and the number of CNS and CAAS “polymorphisms” i.e. CNSPs and CAASPs for each such chromosome/gene or polypeptide. (See FIGS. 7 and 10 at pages 102 and 105). The number of polymorphisms equals the number of CNSs and CAASs for the particular length less the number of duplicate CNSs or CAASs. For example, if the sequence GATTACA were to appear three times for sequence length seven within the sequence data for a chromosome of an individual it would be counted three times in determining the number of CNSs for the chromosome but only once in determining the number of CNSPs. While association data, e.g. the case and control numbers and percentages of occurrence, as well as the RR, x2, and r2 are reported for each CNSP or CAASP, it is the number of CNSs or CAASs that can be reconciled to the computational formula “sequence length of chromosome/gene or polypeptide less the particular length of CNSP or CAASP plus one.” Then the total number of both CNSs or CAASs and CNSPs or CAASPs for all case and control chromosomes/genes or polypeptides at the particular length are aggregated and reported. The working examples provide association data for sequence lengths two through ten. At the end of Section E for sequence length ten is a grand total for the number of CNSs or CAASs and CNSPs or CAASPs for all sequence lengths two through ten in the aggregate.

FIG. 6 at pages 92-101 provides charts that computes CAASs from the computational formula that reconcile to the Section E values for the number of CAASs for the working example for AQ_aa.pl as indicated on the run report for this example, viz. AQ_aa.txt. FIG. 7 at page 102 provides the CAASs and CAASPs for a few particular lengths from AQ_aa.txt. Gene-specific CNSs and CAASs can be linked to the loci numbers for the genes extracted from the aquifex aeolicus genome, keeping in mind that there are three input nts for a single translated amino acid.

The statistical measures of association for which the user selected ranges of values for output at Section C are reported in Section F, as follows: Subsection F-1 reports the range of the “relative risk” ratios for CNSPs or CAASPs which were selected at subsection C-2. Subsection F-2 reports the range of chi square values for CNSPs or CAASPs which were selected at subsection C-3. Subsection F-3 reports the range of phi correlation coefficients for CNSPs or CAASPs which were selected at subsection C-4. The RR, x2, and r2 are reported continuously for each nt of the first tRNA gene listed on the run report for homo sapiens working example HSnt.txt, which has the anticodon AGC. (See FIG. 11 at pages 106 and 107). This Figure also provides a manual calculation of the RR, x2, and r2 to make clear the operations of the program instructions and application method of calculating these statistics. The reporting of the relative risk ratios, chi square statistics, and phi correlation coefficients with their associated CNSPs in the order that the CNSPs occur along the entirety of the gene or chromosome greatly facilitates the location of loci causally associated with the expression of a phenotype since the value of the statistical association of a particular CNSP is a function of the proximity of the CNSP to nt sequence variants that affect the phenotypic expression, such that the examined CNSP and the causal DNA sequence are inherited together, or linked, by virtue of being located on the same chromosome, with a higher degree of association resulting when the examined CNSP and the causal nt sequence are nearby on the same chromosome rather than when they are further away. The identification of the loci of sequences of nts that cause, even in part, the expression of a disease or trait phenotype can be the first critical step that leads to an understanding of the underlying biological mechanisms for the expression of the phenotype and its subsequent treatment or cure.

Subsections F-4 to F-7 report the range of the number of case/control group sequences for a CNSP or CAASP on which the CNSP or CAASP occurs and does not occur which were designated at subsections C-5 to C-8 for reporting. The results for all subsections of Section F, i.e. F-1 through F-8, are sorted both alphabetically by CNSP or CAASP with the CNSP or CAASP appearing in alphabetical order with the numerical value of the measure of association listed beside, and by the numerical value of the measure from highest to lowest appearing with the CNSP or CAASP appearing beside. (See FIG. 1 at page 86 for these sorts for sections F-1, F-2 and F-3 involving the RR, x2, and r2 respectively). Sorting alphabetically allows the user to obtain the observed statistic for a measure of association for a particular CNSP or CAASP by locating the particular CNSP or CAASP on the alphabetized list and then reading the statistical measure beside the particular CNSP or CAASP of interest. Sorting by the value of the measure allows the user to identify which CNSPs or CAASPs have the highest and lowest values within the range designated by the user for the measure, as well as to identify the distribution of values across the selected range of results.

Subsection F-8 reports the range of the percentage of occurrence of CNSPs or CAASPs within case and control nucleic acid sequences which were designated at subsection C-1. (See FIG. 13 at pages 109 and 110). For subsection F-8 case and control groups are separated with each CNSP or CAASP listed first in alphabetical order with the CNSP or CAASP occurrence percentage appearing beside, and then by occurrence percentage, highest to lowest, with the CNSP or CAASP beside. The data reported at subsection F-8 relate to only that subset of total associations that meet the case and control group CNSP or CAASP occurrence percentage ranges specified at C-1. The gist of this analysis is that rather than designate a statistical measure such as RR, x2, or r2 for reporting, the more transparent measure of “the percentage of case group individuals on which the CNSP or CAASP occurs” and “the percentage of control group individuals on which the CNSP or CAASP occurs” are output to the monitor and run report. For example, the computer user can chose to report only those CNSPs for which the CNSP occurs on between 90% and 100% of case group individuals and occurs on between 0% and 25% of controls, or whatever ranges of percentages the user desires.

Subsection F-8 also distinguishes between “originating” CNSPs or CAASPs whose distinctive base sequence originates at the examined defined length and “derivative” CNSPs or CAASPs whose distinctive sequence originated at a smaller defined length. A polymorphism that arises at a particular length continues for all larger lengths unless it occurs at the end of the input sequence such that fewer than the CNSP/CAASP sequence length number of nts or amino acids remain in the input sequence at the larger length. CNSPs or CAASPs at a defined length with a starting sequence the same as a CNSP or CAASP at a lower defined length are identified as derivatives, whereas CNSPs or CAASPs at a defined length that have a novel starting sequence at the presently examined sequence length that does not occur at lower lengths are identified as originating motifs. Thus, the smallest length at which the distinctive base sequence of the polymorphism occurs is noted. Finally, subsection F-8 also identifies the aggregate number of CNSPs or CAASPs that meet the case and control occurrence percentages at each of the defined lengths two through ten. (See FIG. 13 at pages 109 and 110). This summary report appears only once for the program run at the end of the run report.

FIG. 1 through FIG. 4 provide the lines numbers of the Perl program instructions for the discrete steps of the CNSP and CAASP methodology. These line numbers often contain comment sections that provide a more detailed explanation of how the Perl script works, such as the operations of Perl functions and conditionals. The line numbers of the instructions specified by the Perl program are processed linearly by line number order, starting with the first line number and progressing in order to the last, with the sole exception of a few lines of the aquifex aeolicus amino acid program for which non-linear processing occurs for a Perl subroutine that converts nt-triplet sequence codons into single letter amino acid sequences corresponding to the assignments of the genetic code.

The Section A input sequences for the working example involving homo sapiens tRNA genes consists of the DNA nt sequences of 46 different tRNA genes each with a different anticodon. The Section A input sequences for the working example involving homo sapiens aaRS enzyme genes consist of amino acid sequences of 18 different aaRS enzyme genes. Each homo sapiens sequence was manually placed into the Perl program instructions as a contiguous sequence of single letter nucleic or amino acids. The tRNA genes and aaRS genes of homo sapiens naturally contain introns, but introns had already been removed from the tRNA gene and aaRS enzyme sequence data that was manually input for the homo sapiens working examples. Step 1 of the homo sapiens working examples involves identifying the input DNA sequences by displaying the first portion of each input sequence to the computer monitor screen and to the run report, whereas step two of the homo sapiens tRNA gene working example and steps 2 and 3 of the homo sapiens aaRS enzyme working examples involves summing the nts of the input sequences. These steps provide diagnostic tools to confirm that the input sequence data is fully read into the Perl data structures (e.g. scalars, arrays, and associative arrays also called hashes) which are housed in the memory devices of the computer for subsequent processing by the computer.

For the working examples involving aquifex aeolicus the input DNA sequences consist of 39 tRNA gene sequences each with a different anticodon as well as 18 different aaRS enzyme amino acid sequences. Each of these are extracted from the whole-genome of aquifex aeolicus, consisting of a single chromosome which is about 1.5 million nts in length. Several aaRS enzymes had two sub-components, such that a total of twenty-four aaRS enzyme genes were extracted from the aquifex aeolicus genome, but the subunits were concatenated into 18 aaRS enzymes for the working example analysis. The whole-genome of aquifex aeolicus was input by reference to an external Microsoft notepad text file containing the sequence of nts for the entire genome. Thus, a few more steps were involved in reading in the DNA and amino acid input data for the aquifex aeolicus working examples than for the homo sapiens examples. For example, FIG. 3, of the aquifex aeolicus tRNA gene example identifies steps 1 through 14 for Section A input data, whereas steps 1 through 11 are listed for Section A at FIG. 4 for the aquifex aeolicus aaRS enzyme gene example. The discrete steps involved in the aquifex aeolicus aaRS enzyme gene example cover nearly all of the major steps involved in processing among all four working examples, and for that reason the discrete steps for the aquifex aeolicus aaRS enzyme working example described by FIG. 4 are addressed in further detail below.

Step 1 from FIG. 4 describes the identification of the external file for the input DNA sequence data of the aquifex aeolicus genome. The DNA input file, consisting of the sequence data for the single chromosome of the bacterium aquifex aeolicus, was obtained by downloading and opening a html file from the NCBI website. The contents of the html file were copied to the Microsoft clipboard and pasted into a Microsoft notepad document. The DNA input file for the aquifex aeolicus chromosome, which contained about 1.5 million nts, was read from the Microsoft notepad text file into a Perl scalar variable using the reference to an external file that was assigned to a Perl scalar variable.

Step 2 from FIG. 4 checked whether the designated DNA sequence input file existed, with a message returned to the screen if it didn't. Step 3 read the scalar variable containing the input sequence into a Perl “file handle” which converted data obtained from the external file into the Perl format. Step 4 assigned the contents of the file handle into a Perl array, which is a list of elements. By using the array each of the elements of the array, which are individual nts, was read in altogether as a single operation. Step 5 prepared the contents of the aquifex aeolicus DNA sequence data for use by first using the Perl “join” function to join the elements of the array together into a single continuous scalar. The join function removed any white spaces between the elements (i.e. nts) making a single scalar consisting of a continuous sequence of nts uninterrupted by white space. Similar functions were used to remove numerical data, if any had existed, that may have erroneously contaminated the sequence file. As a check to test whether the data for the DNA source file was properly input a count of each of the four types of nt bases, i.e. T, C, A or G was made, at Step 6. The total for each type of nt base was summed to derive the total nt count for the source file (e.g. the aquifex aeolicus genome) which was compared with the count listed in the NCBI annotation. To count the nts, it was first necessary to initialize “counter” variables to zero and then reset the count to zero each time the program ran. Each particular nucleotide had its own counter. The input DNA sequence file, now consisting of the contiguous nts of the single chromosome of the bacterium was searched for each nt separately, with instructions to increase the value assigned to the particular counter variable each time that the particular nt base occurred within the input DNA. A “while” loop continued through the DNA input file and whenever it found a match to “a” or “A” it added 1 to the latest count of a's. The same was done for the c's, t's and g's. The results of the counts were then displayed to the computer screen and to the run report text file.

Step 7 prepared for the extraction of nt or amino acid data pertaining to specific genes from the sequence data of the chromosome of the bacterium. In order to extract DNA sequences pertaining to genes that do not occur on the single strand of the DNA double helix for which sequence data was obtained from the NCBI it was necessary to derive a strand of the DNA double helix that was the Watson-Crick complement to the sequence of DNA on the strand provided by the NCBI because the sense strand for the genes of interest (e.g. the aaRS enzyme genes for the working prototype for FIG. 4) may be on either the strand of the double helix for which the NCBI provided DNA sequence data or on the complement to the strand of the double helix for which the NCBI provided DNA sequence data for which the NCBI did not provide any data. Constructing a W-C complementary strand first involved counting the total number of nucleotide bases along the single strand of the double helix provided by the NCBI as was previously described. Then in order to derive the sequence of DNA nts for genes that occur on the complement to the DNA strand provided by the NCBI it was necessary to “reverse transliterate” the source DNA strand obtained from the NCBI. The Perl “reverse” function reverses the direction of a string of text. For example, ACTG becomes GTCA. The Perl “transliterate” function changes one letter of text in a string to a different letter, here A to T and vice versa and C to G and vice versa. Reverse transliterating makes a second strand that in vivo would be a W-C complement to the source DNA strand from the NCBI but in vivo running in an antiparallel 5′-3′ direction.

Step 8 on FIG. 4 explains and comments on the process of “filtering” the results of matches of CAASPs (or of CNSPs in the companion program) so that only those results that meet the user-defined prerequisites as to percentage of occurrence of case and control groups are output later at section F-8 of the run report. Step 9 begins the extraction of subsets from the chromosome corresponding to the nt sequences of the aaRS enzyme genes. The beginning and ending loci numbers of the first aaRS enzyme gene were identified from the NCBI annotation and manually input into the Perl program instructions. Also manually input was an indication taken from the annotation of whether the gene occurs on the NCBI-provided strand or its complement. These loci, as well as the length of the chromosome, were used as arguments for the Perl substring function that extracts a subset of nts from one of the two strands of the double helix of the chromosome. After extraction, the first 38 nts from the first aaRS gene nt sequence were printed to the computer screen and output text file to permit a visual indication by comparison against the NCBI annotation as to whether the proper sequence data was extracted for the gene and translated. The NCBI annotation contains not only each nt in sequence for the entire genome, but also the loci numbers for genes, and for protein-coding genes the translated amino acids. Thus, the extracted data was visually compared against the NCBI annotation to confirm that the proper sequence data were extracted.

Step 10 of FIG. 4 describes the in silica translation of nt-triplet sequences or “codons” from the extracted aaRS enzyme genes into single letter amino acid sequences, following the assignments of codons into cognate amino acids of the canonical genetic code, by invoking a Perl program translation subroutine. This first involves subsetting nt-triplet sequences from the gene using a “for” loop. The “for” loop operation first identifies a pointer variable which is initially assigned the value 0 (zero) instead of 1 since zero is the starting position number in Perl for positions in a scalar string. The value of the pointer variable then is incremented by 3 each time the process loops, so that the pointer position for the second iteration of the for loop starts at the fourth position, i.e. number 3 (i.e. 0, 1, 2, 3) and the subsequent iteration extracts the next codon. Each codon is extracted seriatim by the for loop over the length of the aaRS enzyme gene nt sequence until less than 3 nts remain. Each codon so extracted is processed by the subroutine. Passing the extracted codons to the subroutine returns the single letter amino acid equivalent of the codon placing it into a scalar by virtue of the associative array structure of the subroutine that links a particular three-nt codon with a particular single letter amino acid designation. Perl's “dot concatenator” then puts together all codons into a single contiguous sequence of single letter amino acid letters that are printed to the computer screen and run report at Section E to enable confirmation that the proper amino acid sequence was extracted.

Step 11 of FIG. 4 completed the processes described by Steps 9 and 10 of subsetting nt sequence data for genes from the aquifex aeolicus chromosome and converting the sequence of nt-triplet codons from the genes into single letter amino acid sequences for the remaining 23 aaRS genes for the working prototype detailed by FIG. 4. The second through 24th aaRS genes follow nearly the same operations as described above for the first sequence. As with the first sequence, the nts for the genes were extracted from the genome and the first 38 nts of the gene were printed for confirmation of accuracy of input, and the nt sequence of the genes was converted into single-letter amino acid sequences the first 38 of which were also displayed.

Step 12 of FIG. 4 comprises Section B of the run report. It involves designating which input gene sequences are classified as case group members and which sequences are classified as control group members. For the FIG. 4 working example, the classifications for the input sequences themselves was made earlier in the script than at the listed line numbers for Step 12 by assigning the classifications to case and control group listing variables. These variables were then read in at the line numbers for Step 12.

Steps 13 to 20 of FIG. 4 comprises Section C of the run report. It identifies: at C-1 manual input data that designates the range of case and control group occurrence percentages for reporting at section F-8 of the run report for which comments were included at step 8; at C-2 input data that designates the range of “relative risk” ratios of case to control group occurrence percentages for output to section F-1; at C-3 input data that designates the range of chi square statistics for output to section F-2; at C-4 manual input data that designates the range of phi correlation coefficients for output to section F-3; and at C-5 to C-8 input data that designates the range of the number of case and control group sequences on which each CAASP occurs and does not occur for output to sections F-4 to F-7 of the run report.

Step 21 of FIG. 4 involves the subroutine for the conversion of codons into amino acids that was called at Step 10. The subroutine, which appears at the program lines for Step 21, can be placed almost anywhere in the program, but is placed at the end of Section C since Sections A, B, and C are included only once in the program and run report whereas Sections D, E, and F are repeated in the program and run report once for each particular length of CAASP examined by the program run. The working examples provide association data for CNSPs and CAASPs with particular lengths two through and including ten. Step 22 for FIG. 4 represents Section D, which contains the input data that sets the particular length for the CNSPs or CAASPs.

Step 23 for the FIG. 4 working example involving CAASPs relates to Section E of the run report, and lists for visual confirmation the first 38 amino acids for each case or control group amino acid sequence individually for which the translation by subroutine was previously explained. It also computes and reports the number of amino acid sequences of the particular length, i.e. CAASs, for each input case or control group amino acid sequence individually, both with and without duplicates. CAASPs are CAASs with duplicates removed. A report is also made of the number of CAASs for the aggregate of all case or control group amino acid sequences at the particular length, both with and without duplicates. For the FIG. 3 working example involving CNSPs, Section E lists the first 38 nts for each case or control group nt sequence individually. It also computes and reports the number of nts of the particular length, i.e. CNSs, for each input case or control group nt sequence individually, both with and without duplicates. A report is also made of the number of CNSs for the aggregate of all input case or control group nt sequences in the aggregate, both with and without duplicates. CNSPs are CNSs with duplicates removed.

A “for” loop is used to extract each CAAS of the defined length from the contiguous string of single letter amino acids. Sequences of the designated length are first extracted beginning with the first single letter amino acid of the case or control amino acid sequence, and when extracted the CAAS is pushed into an array using Perl's “push” function. After extracting for the length of the sequence until no more CAASs of the designated length remain, the point of extraction of single letter amino acids of the designated particular length from the scalar then moves to the second single letter amino acid of the case or control amino acid input sequence for the second iteration of the program operation and from that point extracts sequences of the designated length for the length of the case or control group sequence until less single letter amino acids than the designated particular length remain, then the point of extraction moves to the third amino acid position in the case or control group sequence for the third iteration and from that point extracts sequences of the designated length, and this continues seriatim. Throughout this process each CAAS that is extracted from the case or control group aaRS sequence of single letter amino acids is pushed onto a Perl array using Perl's “push” function.

A Perl “hash” which is also called an “associative array” is then used with a “foreach” loop to remove duplicates of the CAAS or CNS of designated length in the extracted single letter amino acid or nt sequence. To remove duplicate CNSs or CAASs of the same length the elements (e.g. CAASs) that were pushed into the initial array are read as Perl “keys” into a Perl “hash.” Then the keys of the hash are output into an array without duplicated elements since associative arrays retain only a single instance of paired items. This removes the duplicate CNSs or CAASs leaving only the CNSPs or CAASPs. To obtain the aggregate number of CAASs (or CNSs) in the arrays with duplicates the array (which is a group of individual items) is assigned to a scalar (which is a single item) returning the number of elements of the array with duplicates to the scalar. The scalar number is then printed to the computer monitor and to the run report. In a similar manner totals for the arrays without duplicates, i.e. CNSPs and CAASPs, are derived and printed out.

The FIG. 4 Step 24 initiates the counter variables for the counts of the number of case and control group sequences that match the CAASP (or CNSP) probes. Counters for both positive matches or “hits” and counters for negative matches or “misses” are used. These counts are used in determining the association statistics later in the program. The counter variables are initialized at zero value and are thereafter reset to zero each time the program runs.

Step 25 on FIG. 4 matches each CAASP (or CNSP for the companion working example) of the particular sequence length against each case or control sequence of amino acids (or nts for the companion programs) to ascertain whether the CAASP (or CNSP) is within the particular case or control group sequence, such as polypeptide or chromosome/gene sequence data, that is examined. Each CAASP or CNSP is used as a Perl “regular expression” probe to match against each case and control group sequence with the appropriate counters increased when they match or other counters are increased when they do not match.

A count is, thus, made of each successful match of a CAASP (or CNSP) to each case or control sequence and also a count is made of each unsuccessful match. Counter variables are further set up for case group and control group designations, so that counts are taken of the number of case group sequences on which the CAASP (or CNSP) occurs and does not occur, as well as the number of control group sequences on which the CAASP (or CNSP) occurs and does not occur. It is the case and control group successful match and unsuccessful match counter totals that are used for the computation of the association statistics.

Based on the match count totals, Step 26 of FIG. 4 computes for each CAASP or CNSP the percentage of matches for the case group variables and percentage of matches for control group variables, with the percentage being the occurrence number divided by the occurrence number plus non-occurrence number multiplied by 100. Similarly, based on the match count totals, Step 27 of FIG. 4 computes for each CAASP or CNSP the relative risk as the ratio of case group occurrence percentage to control group occurrence percentage. If both the case group count and the control group count is zero the value of the relative risk ratio is set to zero, rather than the value “undefined” which is the standard arithmetic answer for the result when dividing by zero. If the case group count exceeds zero, i.e. the CAASP or CNSP occurs among case group sequences, but the control group count is zero, the relative risk is set to equal the case group count times 1.0001. For example, if there are five case group sequences on which a CNPS/CAASP occurs but no control group sequences the reported relative risk ratio is (5*1.0001)=5.0005. The three zeros after the decimal point followed by the same figure before the decimal is a flag that there are no control occurrences and that the figure to the left of the decimal is the number of case group occurrences. This adjustment is made to the relative risk value because of the difficulty of detecting rare variants. Rare variants occur so infrequently and are so overwhelmed by non-occurrences that ordinarily tens of thousands of case and control group sequences are needed to have the statistical power to detect appreciable levels of significance or correlation, which is ordinarily an impracticable large sample size. However, with the adjustment described above rare variants that occur on case group sequences but not on control group sequences are readily detectable even with small numbers of case and control sequences. If a CNSP/CAASP occurs on control group sequences but not on case group sequences the value for the relative risk is set at 0.00012345. This small figure is another flag. If the CNSP/CASSP occurs on both case and control sequences then the relative risk ratio is computed in accord with its standard definition as the ratio of the case occurrence percentage to control occurrence percentage, in which case rare variant detection also occurs.

Also based on the match count totals, Step 28 of FIG. 4 computes for each CAASP or CNSP the chi square statistic. First, this section computes the expected frequencies of four outcomes from the match results (namely case occur, case not occur, control occur, control not occur). The standard chi square is computed when the expected frequency of each outcome equals or exceeds five. Where the expected frequency of any outcome is less than five and outcomes have expected frequencies greater than one, the standard chi square statistic was adjusted by the factor (N−1/N) in accord with the Pearson adjustment to the chi square statistic to account for small numbers of observations. See, Campbell I. “Chi squared and Fisher-Irwin tests of two by two tables with small recommendations.” (2007) Statistics in Medicine 26, 3661-3675. For associations with an outcome with an expected frequency of less than one reliable chi square statistics cannot be derived and a chi square value of 0.00012345 is assigned. This is not a significant value and the distinctiveness of the figure indicates that the association has an outcome with an expected frequency of less than one. The present methodology identifies at sections F-4 to F-7 the number of instances that the CASSP (or CNSP) occurs on case group sequences, does not occur on case group sequences, occurs on control group sequences, and does not occur on control group sequences. Thus, a Fisher's exact or other statistics of probability for association can be independently computed, if desired, from the data output for associations assigned a 0.00012345 chi square value (or for any other association as well).

Also specified is the number of different CAASP (or CNSP) associations to the same case and control phenotype from which the reported statistics were derived for consideration if the user desires to make a Bonferroni correction to the level of probability for the chi square (or Fisher's exact) statistic to control for false positives resulting from repeated tests on the same data. The degree of freedom for the chi square associations for the present method is one (i.e., # rows−1*# columns−1), given the 2×2 contingency table configuration with two dichotomous or categorical variables, i.e. the CAASP (or CNSP) either occurs or not on either the case or control group polypeptide (or chromosome/gene) sequence. The number of associations upon which the chi square statistics were computed for the Bonferroni correction, if desired, is specifically listed as output to the computer monitor and run report.

Based on the match count totals, Step 29 of FIG. 4 computes for each CAASP or CNSP the phi correlation coefficient. The phi coefficient, which is a special case Pearson r2 with two dichotomous variables, is reported for each association. It is calculated as the square root of the chi square first divided by total (case and control) sequences examined. Whereas the chi square statistic is a measure of the probability of the association, the phi correlation coefficient measures the strength of the association between the CAASP (or CNSP) genotype and the phenotype. The phi correlation coefficient calculation was not adjusted for small sample size. The chi square and phi correlation coefficients are based on frequency data which is never negative. Therefore, both the chi square and the phi correlation coefficients have only positive values with the phi correlation ranging from 0 to 1 with zero representing no correlation and 1.0 representing a perfect correlation between CAASP or CNSP occurrence on sequence data and whether the sequence data is from case group members as opposed to control group members.

Based on the match count totals, Step 30 of FIG. 4 indicates for each CAASP (or CNSP) the number of case and control group sequences on which the CAASP (or CNSP) does and does not occur, as reported at sections F-4 to F-7, if the user selects this data for reporting.

Steps 31 to 37 of FIG. 4, Sections F-1 to F-7 of the run report, provide sorts of computed results for relative risks, chi squares, correlation coefficients, and the number of CAASP (or CNSP) occurrences for case and control groups, in accord with the ranges established earlier in the program from the user's selection of results for display to the monitor and the run report. The RR, x2, and r2 are reported in three ways: (1) alphabetically by CAASP (or CNSP) with statistical value, (2) by statistical value from highest to lowest followed by CAASP (or CNSP), or (3) by CAASP (or CNSP) in the order in which they occur on the case or control group member polypeptides (or chromosomes/genes) followed by the statistical value. For the last listing, if the value of the statistic is not reported because it is not within the range selected by the user for output, beside the CAASP (or CNSP) in the order it appears on the polypeptide (or chromosome/gene) is the notation “( )” which refers to the empty set. The number of CAASP (or CNSP) occurrences for case and control groups are reported only two ways, viz. alphabetically and by statistical value, for those results that accord with the ranges set by the computer user.

Conditionals are established for the sorts of the various statistics at Steps 31 to 37. The conditionals output results to arrays when the computed results meet the ranges that are established earlier in the program based on the user's preferences. The results output to the arrays have two components, each of which is initially put into a separate array. One component is the numeric value of the statistic that passes the conditionals. The other component is the associated CAASP (or CNSP) for the statistic that passes the conditionals. The two separate arrays, one of values and the other of the CAASPs (or CNSPs) are then read into a single array with the identity of the CAASP (or CNSP) followed by its value. When this combined array is sorted as a hash the sequential elements of the array are paired up as hash keys and hash values. Like arrays, Perl hashes are lists of values but unlike arrays, hashes (which are also called associative arrays) consist of “paired” lists. The keys are sorted alphabetically whereas the numbered values are sorted in numeric order.

Steps 38 and 39 of FIG. 4 relate to only that subset of total associations that meet the case and control group CNSP or CAASP occurrence percentage ranges specified at C-1. For case and control groups separately each CNSP or CAASP is listed first in alphabetical order with the CNSP or CAASP occurrence percentage appearing beside, and then by occurrence percentage, from highest to lowest, with the CNSP or CAASP beside.

Step 40 of subsection F-8 distinguishes between “originating” CNSPs or CAASPs whose distinctive base sequence originates at the examined defined length and “derivative” CNSPs or CAASPs whose distinctive sequence originated at a smaller defined length. CNSPs or CAASPs at a defined length with a starting sequence the same as a CNSP or CAASP at a lower defined length are identified as derivatives, whereas CNSPs or CAASPs at a defined length that have a novel starting sequence at the present sequence length not occurring at lower lengths are identified as originating motifs.

Finally, Step 41 for subsection F-8 identifies the number of CNSPs or CAASPs that meet the case and control occurrence percentages at each of the defined lengths two through ten, distinguishing between originating and derivative CNSPs or CAASPs. This summary report, which specifies the number of originating and derivative CNSPs or CAASPs at sequence lengths two through ten, appears only once for the program run at the end of the run report.

The foregoing descriptions in the specification are intended to be illustrative and not restrictive. All cited references, including patent and non-patent literature, are also incorporated by reference.

The claimed invention involves:

1. Computer-implemented processes of associating digital representations of each contiguous nucleic acid sequence polymorphism (CNSP) of particular sequence lengths between two (2) through and including ninety-nine (99) from the aggregate of the nucleic acid sequence data of both individuals that express an examined phenotype and individuals that do not express the phenotype, with the separate nucleic acid sequence data of each individual that expresses the phenotype and the separate nucleic acid sequence data of each individual that does not express the phenotype, comprised of the following steps:
a) inputting nucleic acid sequence data which has been reduced to a single-letter nucleic acid digital form from an individual or individuals that express an examined phenotype and inputting other nucleic acid sequence data which has been reduced to a single-letter nucleic acid digital form from an individual or individuals that do not express the examined phenotype, into the data structures of a computer programming language and the permanent memory devices of a computer,
b) reporting, if indicated by the computer user, separately for each sequence of each individual whose data is input, for display to a computer monitor and for output to a text file, the input nucleic acid sequence data or a subset of the input sequence data such as the first few dozen nucleic acids of the sequence,
c) counting, if indicated by the computer user, separately for each sequence of each individual whose data is input, the number of nucleic acids of each type represented by the standard single-letter nomenclature A, C, T and G, summing the total for all four types in the aggregate, and reporting to a computer monitor and to a text file the separate counts of the number of each type of nucleic acid for each sequence and the sum of all four nucleic acids in the aggregate for the sequence,
d) inputting an indication of whether input sequences are from individuals that express the examined phenotype or are from individuals that do not express the phenotype,
e) inputting an indication of a particular sequence length between two and ninety-nine, or particular sequence lengths between two and ninety-nine, for the contiguous nucleotide sequence polymorphisms (CNSPs) that are associated with the sequence data of individuals that express the phenotype and the sequence data of individuals that do not express the phenotype,
f) identifying and reporting to the computer monitor and text file, if indicated by the computer user, the number of contiguous nucleic acid sequences (CNSs) of each particular sequence length or lengths, including duplicates of the same sequence at the same length, separately for each input sequence from each individual whose sequence data was input, and also identifying and reporting, if indicated by the computer user, the aggregate number of all contiguous nucleic acid sequences (CNSs) at each particular sequence length or lengths, including duplicates of the same sequence at the same length, for the aggregate of all input sequences from all individuals whose sequence data was input,
g) identifying and reporting to the computer monitor and text file, if indicated by the computer user, the number of contiguous nucleic acid sequence polymorphisms (CNSPs) of each particular sequence length or lengths, excluding duplicates of the same sequence at the same length, separately for each input sequence from each individual whose sequence data was input, and also identifying and reporting, if indicated by the computer user, the aggregate number of all contiguous nucleic acid sequence polymorphisms (CNSPs) at each particular sequence length, excluding duplicates of the same sequence at the same length, for the aggregate of all input sequences from all individuals whose sequence data was input,
h) detecting whether each contiguous nucleic acid sequence polymorphism (CNSP) of a particular sequence length or lengths from the aggregate of the nucleic acid sequence data of both individuals that express the phenotype and individuals that do not express the phenotype, occurs within the nucleic acid sequence data of each individual that expresses the phenotype and occurs within the nucleic acid sequence data of each individual that does not express the phenotype,
i) counting for each CNSP of a particular sequence length or lengths from the aggregate of the nucleic acid sequence data of both individuals that express the phenotype and individuals that do not express the phenotype, the number of individuals that express the phenotype on whose sequence data the CNSP occurs, and counting the number of individuals that express the phenotype on whose sequence data the CNSP does not occur, and counting the number of individuals that do not express the phenotype on whose sequence data the CNSP occurs, and counting the number of individuals that do not express the phenotype on whose sequence data the CNSP does not occur,
j) computing for each CNSP of a particular sequence length or lengths from the aggregate of the nucleic acid sequence data of both individuals that express the phenotype and individuals that do not express the phenotype, based on the foregoing counts of occurrence, the percentage of individuals that express the phenotype on whose sequence data the CNSP occurs and the percentage of individuals that do not express the phenotype on whose sequence data the CNSP occurs,
k) computing for each CNSP of a particular sequence length or lengths from the aggregate of the nucleic acid sequence data of both individuals that express the phenotype and individuals that do not express the phenotype, based on the foregoing counts of occurrence, the relative risk ratio of the percentage of individuals that express the phenotype on whose sequence data the CNSP occurs to the percentage of individuals that do not express the phenotype on whose sequence data the CNSP occurs,
l) computing for each CNSP of a particular sequence length or lengths from the aggregate of the nucleic acid sequence data of both individuals that express the phenotype and individuals that do not express the phenotype, based on the foregoing counts of occurrence, the chi square statistic as to the likelihood that the difference in the number of individuals that express the phenotype on whose sequence data the CNSP occurs and does not occur relative to the number of individuals that do not express the phenotype on whose sequence data the CNSP occurs and does not occur can be attributed to random sampling fluctuations as opposed to non-chance factors,
m) computing for each CNSP of a particular sequence length or lengths from the aggregate of the nucleic acid sequence data of both individuals that express the phenotype and individuals that do not express the phenotype, based on the foregoing counts of occurrence, phi correlation coefficients of the strength of the relationship between the occurrence of the CNSP on the sequence data of examined individuals and the expression of the phenotype in these individuals,
n) selecting for reporting from each CNSP of a particular sequence length or lengths from the aggregate of the nucleic acid sequence data of both individuals that express the phenotype and individuals that do not express the phenotype, the range of the number of individuals that express the phenotype on whose sequence data the CNSP occurs, the range of the number of individuals that express the phenotype on whose sequence data the CNSP does not occur, the range of the number of individuals that do not express the phenotype on whose sequence data the CNSP occurs, and the range of the number of individuals that do not express the phenotype on whose sequence data the CNSP does not occur,
o) selecting for reporting from each CNSP of a particular sequence length or lengths from the aggregate of the nucleic acid sequence data of both individuals that express the phenotype and individuals that do not express the phenotype, the range of the percentage of individuals that express the phenotype on whose sequence data the CNSP occurs, and the range of the percentage of individuals that do not express the phenotype on whose sequence data the CNSP occurs,
p) selecting for reporting from each CNSP of a particular sequence length or lengths from the aggregate of the nucleic acid sequence data of both individuals that express the phenotype and individuals that do not express the phenotype, the range of the the computed relative risk, chi square, and phi correlation coefficient measures of association,
q) reporting, if indicated by the computer user, for each CNSP of a particular sequence length or lengths from the aggregate of the nucleic acid sequence data of both individuals that express the phenotype and individuals that do not express the phenotype, for the sequence data of each individual that expresses the phenotype and the sequence data of each individual that does not express the phenotype, the values of the relative risk, chi square, and phi correlation coefficient measures of association if within the selected ranges, and for those values not within the selected ranges the empty set, listed by CNSP with value or empty set in the order that the CNSP occurs on the nucleic acid sequence data of individuals,
r) reporting, for each CNSP of a particular sequence length or lengths from the aggregate of the nucleic acid sequence data of both individuals that express the phenotype and individuals that do not express the phenotype, the selected range of the numbers of occurrence and the selected range of the percentages of occurrence, and reporting the selected range of the relative risk values, chi square values, and phi correlation coefficient values, listed alphabetically by CNSP with value and listed by values with CNSP,
s) reporting for each CNSP of a particular sequence length or lengths from the aggregate of the nucleic acid sequence data of both individuals that express the phenotype and individuals that do not express the phenotype, for the selected the range of the percentage of individuals that express the phenotype on whose sequence data the CNSP occurs and the range of the percentage of individuals that do not express the phenotype on whose sequence data the CNSP occurs, each originating and each and derivative CNSP, and a summary of the number of CNSPs that meet the percentages for each sequence length from two through ten.

2. Computer-implemented processes of associating digital representations of each contiguous amino acid sequence polymorphism (CAASP) of particular sequence lengths between two (2) through and including ninety-nine (99) from the aggregate of the amino acid sequence data of both individuals that express an examined phenotype and individuals that do not express the phenotype, with the separate amino acid sequence data of each individual that expresses the phenotype and the separate amino acid sequence data of each individual that does not express the phenotype, comprised of the following steps:
a) inputting amino acid sequence data which has been reduced to a single-letter amino acid digital form from an individual or individuals that express an examined phenotype and inputting other amino acid sequence data which has been reduced to a single-letter amino acid digital form from an individual or individuals that do not express the examined phenotype, into the data structures of a computer programming language and the permanent memory devices of a computer,
b) reporting, if indicated by the computer user, separately for each sequence of each individual whose data is input, for display to a computer monitor and for output to a text file, the input amino acid sequence data or a subset of the input sequence data such as the first few dozen amino acids of the sequence,
c) counting, if indicated by the computer user, separately for each sequence of each individual whose data is input the number of amino acids of each type represented by the standard single-letter nomenclature, summing the total for all 20 standard types in the aggregate, and reporting to a computer monitor and to a text file the separate counts of the number of each type of amino acid for each sequence and the sum of all 20 amino acids in the aggregate for the sequence,
d) inputting an indication of whether input sequences are from individuals that express the examined phenotype or are from individuals that do not express the phenotype,
e) inputting an indication of a particular sequence length between two and ninety-nine, or particular sequence lengths between two and ninety-nine, for the contiguous amino acid sequence polymorphisms (CAASPs) that are associated with the sequence data of individuals that express the phenotype and the sequence data of individuals that do not express the phenotype,
f) identifying and reporting to the computer monitor and text file, if indicated by the computer user, the number of contiguous amino acid sequences (CAASs) of each particular sequence length or lengths, including duplicates of the same sequence at the same length, separately for each input sequence from each individual whose sequence data was input, and also identifying and reporting, if indicated by the computer user, the aggregate number of all contiguous amino acid sequences (CAASs) at each particular sequence length or lengths, including duplicates of the same sequence at the same length, for the aggregate of all input sequences from all individuals whose sequence data was input,
g) identifying and reporting to the computer monitor and text file, if indicated by the computer user, the number of contiguous amino acid sequence polymorphisms (CAASPs) of each particular sequence length or lengths, excluding duplicates of the same sequence at the same length, separately for each input sequence from each individual whose sequence data was input, and also identifying and reporting, if indicated by the computer user, the aggregate number of all contiguous amino acid sequence polymorphisms (CAASPs) of each particular sequence length or lengths, excluding duplicates of the same sequence at the same length, for the aggregate of all input sequences from all individuals whose sequence data was input,
h) detecting whether each contiguous amino acid sequence polymorphism (CAASP) of a particular sequence length or lengths from the aggregate of the amino acid sequence data of both individuals that express the phenotype and individuals that do not express the phenotype, occurs within the amino acid sequence data of each individual that expresses the phenotype and occurs within the amino acid sequence data of each individual that does not express the phenotype,
i) counting for each CAASP of a particular sequence length or lengths from the aggregate of the amino acid sequence data of both individuals that express the phenotype and individuals that do not express the phenotype, the number of individuals that express the phenotype on whose sequence data the CAASP occurs, and counting the number of individuals that express the phenotype on whose sequence data the CAASP does not occur, and counting the number of individuals that do not express the phenotype on whose sequence data the CAASP occurs, and counting the number of individuals that do not express the phenotype on whose sequence data the CAASP does not occur,
j) computing for each CAASP of a particular sequence length or lengths from the aggregate of the amino acid sequence data of both individuals that express the phenotype and individuals that do not express the phenotype, based on the foregoing counts of occurrence, the percentage of individuals that express the phenotype on whose sequence data the CAASP occurs and the percentage of individuals that do not express the phenotype on whose sequence data the CAASP occurs,
k) computing for each CAASP of a particular sequence length or lengths from the aggregate of the amino acid sequence data of both individuals that express the phenotype and individuals that do not express the phenotype, based on the foregoing counts of occurrence, the relative risk ratio of the percentage of individuals that express the phenotype on whose sequence data the CAASP occurs to the percentage of individuals that do not express the phenotype on whose sequence data the CAASP occurs,
l) computing for each CAASP of a particular sequence length or lengths from the aggregate of the amino acid sequence data of both individuals that express the phenotype and individuals that do not express the phenotype, based on the foregoing counts of occurrence, the chi square statistic as to the likelihood that the difference in the number of individuals that express the phenotype on whose sequence data the CAASP occurs and does not occur relative to the number of individuals that do not express the phenotype on whose sequence data the CAASP occurs and does not occur can be attributed to random sampling fluctuations as opposed to non-chance factors,
m) computing for each CAASP of a particular sequence length or lengths from the aggregate of the amino acid sequence data of both individuals that express the phenotype and individuals that do not express the phenotype, based on the foregoing counts of occurrence, phi correlation coefficients of the strength of the relationship between the occurrence of the CAASP on the sequence data of examined individuals and the expression of the phenotype in these individuals,
n) selecting for reporting from each CAASP of a particular sequence length or lengths from the aggregate of the amino acid sequence data of both individuals that express the phenotype and individuals that do not express the phenotype, the range of the number of individuals that express the phenotype on whose sequence data the CAASP occurs, the range of the number of individuals that express the phenotype on whose sequence data the CAASP does not occur, the range of the number of individuals that do not express the phenotype on whose sequence data the CAASP occurs, and the range of the number of individuals that do not express the phenotype on whose sequence data the CAASP does not occur,
o) selecting for reporting from each CAASP of a particular sequence length or lengths from the aggregate of the amino acid sequence data of both individuals that express the phenotype and individuals that do not express the phenotype, the range of the percentage of individuals that express the phenotype on whose sequence data the CAASP occurs, and the range of the percentage of individuals that do not express the phenotype on whose sequence data the CAASP occurs,
p) selecting for reporting from each CAASP of a particular sequence length or lengths from the aggregate of the amino acid sequence data of both individuals that express the phenotype and individuals that do not express the phenotype, the range of the the computed relative risk, chi square, and phi correlation coefficient measures of association,
q) reporting, if indicated by the computer user, for each CAASP of a particular sequence length or lengths from the aggregate of the amino acid sequence data of both individuals that express the phenotype and individuals that do not express the phenotype, for the sequence data of each individual that expresses the phenotype and the sequence data of each individual that does not express the phenotype, the values of the relative risk, chi square, and phi correlation coefficient measures of association if within the selected ranges, and for those values not within the selected ranges the empty set, listed by CAASP with value or empty set in the order that the CAASP occurs on the amino acid sequence data of individuals,
r) reporting, for each CAASP of a particular sequence length or length from the aggregate of the amino acid sequence data of both individuals that express the phenotype and individuals that do not express the phenotype, the selected range of the numbers of occurrence and the selected range of the percentages of occurrence, and reporting the selected range of the relative risk values, chi square values, and phi correlation coefficient values, listed alphabetically by CAASP with value and listed by values with CAASP,
s) reporting for each CAASP of a particular sequence length or lengths from the aggregate of the amino acid sequence data of both individuals that express the phenotype and individuals that do not express the phenotype, for the selected the range of the percentage of individuals that express the phenotype on whose sequence data the CAASP occurs and the range of the percentage of individuals that do not express the phenotype on whose sequence data the CAASP occurs, each originating and each and derivative CAASP, and a summary of the number of CAASPs that meet the percentages for each sequence length from two through ten.

3. The method of claim 1, wherein the input nucleic acid sequence data which was reduced to a digital form is directly put into the programming instructions.

4. The method of claim 1, wherein the input nucleic acid sequence data which was reduced to a digital form is not directly put into the programming instructions but instead the input nucleic acid sequence data is called by programming instructions from an external file comprised of the sequence of nucleic acids of a single strand of the DNA double helix, further comprising constructing a Watson-Crick complementary strand to the input strand by reverse transliterating the input strand, and then extracting the sequence data from which the CNSPs are derived from either of the two strands of the double helix, namely the input strand or its Watson-Crick complement.

5. The method of claim 1, wherein the input nucleic acid sequence data which was reduced to a digital form is not directly put into the programming instructions but instead the input nucleic acid sequence data is called by programming instructions from an external file comprised of the sequence of nucleic acids of both strands of the DNA double helix, further comprising extracting the sequence data from which the CNSPs are derived from either of the two strands of the double helix.

6. The method of claim 2, wherein the input amino acid sequence data which was reduced to a digital form is directly put into the programming instructions.

7. The method of claim 2, wherein the input amino acid sequence data which was reduced to a digital form is not directly put into the programming instructions but instead what is input is nucleic acid sequence data that is called by programming instructions from an external file comprised of the sequence of nucleic acids of a single strand of the DNA double helix, further comprising constructing a Watson-Crick complementary strand to the input strand by reverse transliterating the input strand, and then extracting nucleic acid sequence data from protein coding genes from either one of the two strands of the double helix, and then bioinformatically translating the extracted nucleic acid sequence data into the amino acid sequence data from which the CAASPs are derived.

8. The method of claim 2, wherein the input amino acid sequence data which was reduced to a digital form is not directly put into the programming instructions but instead what is input is nucleic acid sequence data that is called by programming instructions from an external file comprised of the sequence of nucleic acids of both strands of the DNA double helix, further comprising extracting the sequence data from which the CAASPs are derived from either of the two strands of the double helix, and then bioinformatically translating the extracted nucleic acid sequence data into the amino acid sequence data from which the CAASPs are derived.
